(19) United States
(12) Patent Application Publication
(10) Pub. No.: US 2023/0308779 A1
(43) Pub. Date: Sep. 28, 2023

(54) INFORMATION PROCESSING DEVICE, INFORMATION PROCESSING SYSTEM, INFORMATION PROCESSING METHOD, AND INFORMATION PROCESSING PROGRAM

(71) Applicant: Sony Group Corporation, Tokyo (JP)

(72) Inventors: Suguru AOKI, Tokyo (JP); Ryuta SATOH, Tokyo (JP); Keitaro YAMAMOTO, Tokyo (JP)

(73) Assignee: Sony Group Corporation, Tokyo (JP)

(21) Appl. No.: 18/003,923

(22) PCT Filed: Jun. 25, 2021
(86) PCT No.: PCT/JP2021/024181

§ 371 Date: Dec. 30, 2022

(30) Foreign Application Priority Data
Jul. 20, 2020 (JP) 2020-123647

(51) Int. Cl. H04N 25/44; H04N 25/47; G06V 10/72

(52) U.S. Cl. CPC H04N 25/44; H04N 25/47; G06V 10/72

(57) ABSTRACT

Provided are an imaging device, an imaging system, an imaging method, and an imaging program capable of preventing a reliability degree from decreasing in accuracy even in a case where recognition processing is performed using a partial region of image data.

An information processing device includes a reading unit configured to set, as a read unit, a part of a pixel region in which a plurality of pixels is arranged in a two-dimensional array, and control reading of a pixel signal from a pixel included in the pixel region, and a reliability degree calculation unit configured to calculate a reliability degree of a predetermined region in the pixel region on the basis of at least one of an area, a read count, a dynamic range, or exposure information of a region of a captured image, the region being set and read as the read unit.

### TECHNICAL FIELD

The present disclosure relates to an information processing device, an information processing system, an information processing method, and an information processing program.

### BACKGROUND ART

With a recent increase in functionality of imaging devices such as digital still cameras, digital video cameras, and small cameras mounted on multifunctional mobile phones (smartphones), imaging devices having an image recognition function of recognizing a predetermined object included in a captured image have been developed. Furthermore, an increase in speed of recognition processing has been made using a partial region of image data in one frame. Furthermore, in the recognition processing, a reliability degree is generally given as an evaluation value of recognition accuracy.

In a new recognition method using a partial region, such as line image data, however, the number of lines or the line width may be changed in accordance with a recognition target. For this reason, there is a possibility that the conventional reliability degree makes the accuracy lower.

### CITATION LIST

### Patent Document

Patent Document 1: Japanese Patent Application Laid-Open No. 2017-112409

### SUMMARY OF THE INVENTION

### Problems to be Solved by the Invention

One aspect of the present disclosure provides an information processing device, an information processing system, an information processing method, and an information processing program capable of preventing a reliability degree from decreasing in accuracy even in a case where recognition processing is performed using a partial region of image data.

### Solutions to Problems

In order to solve the above-described problems, the present disclosure provides an information processing device including:
a reading unit configured to set, as a read unit, a part of a pixel region in which a plurality of pixels is arranged in a two-dimensional array, and control reading of a pixel signal from a pixel included in the pixel region; and
a reliability degree calculation unit configured to calculate a reliability degree of a predetermined region in the pixel region on the basis of at least one of an area, a read count, a dynamic range, or exposure information of a region of a captured image, the region being set and read as the read unit.

The reliability degree calculation unit may include a reliability degree map generation unit configured to calculate a correction value of the reliability degree for each of the plurality of pixels on the basis of at least one of the area, the read count, the dynamic range, or the exposure information of the region of the captured image and generate a reliability degree map in which the correction values are arranged in a two-dimensional array.

The reliability degree calculation unit may further include a correction unit configured to correct the reliability degree on the basis of the correction value of the reliability degree.

The correction unit may correct the reliability degree in accordance with a measure of central tendency of the correction values based on the predetermined region.

The reading unit may read the pixels included in the pixel region as line image data.

The reading unit may read the pixels included in the pixel region as grid-like or checkered sampling image data.

A recognition processing execution unit configured to recognize a target object in the predetermined region may be further included.

The correction unit may calculate the measure of central tendency of the correction values on the basis of a receptive field in which a feature in the predetermined region is calculated.

The reliability degree map generation unit may generate at least two types of reliability degree maps on the basis of each of at least two pieces of the information regarding an area, the information regarding a read count, the information regarding a dynamic range, or the information regarding exposure, and the information processing device may further include a combining unit configured to combines the at least two types of reliability degree maps.

The predetermined region in the pixel region may be a region based on at least one of a label or a category associated with each pixel by semantic segmentation.

In order to solve the above-described problems, provided according to an aspect of the present disclosure is an information processing system including:
a sensor unit having a plurality of pixels arranged in a two-dimensional array; and
a recognition processing unit, in which
the recognition processing unit includes:
a reading unit configured to set, as a read unit, a part of a pixel region of the sensor unit, and control reading of a pixel signal from a pixel included in the pixel region; and
a reliability degree calculation unit configured to calculate a reliability degree of a predetermined region in the pixel region on the basis of at least one of an area, a read count, a dynamic range, or exposure information of a region of a captured image, the region being set and read as the read unit.

In order to solve the above-described problems, provided according to an aspect of the present disclosure is an information processing method including:
setting, as a read unit, a part of a pixel region in which a plurality of pixels is arranged in a two-dimensional array, and controlling reading of a pixel signal from a pixel included in the pixel region; and
calculating a reliability degree of a predetermined region in the pixel region on the basis of at least one of an area, a read count, a dynamic range, or exposure information of a region of a captured image, the region being set and read as the read unit.

In order to solve the above-described problems, provided according to an aspect of the present disclosure is a program for causing a computer to execute as a recognition processing unit:
setting, as a read unit, a part of a pixel region in which a plurality of pixels is arranged in a two-dimensional array, and controlling reading of a pixel signal from a pixel included in the pixel region; and
calculating a reliability degree of a predetermined region in the pixel region on the basis of at least one of an area, a read count, a dynamic range, or exposure information of a region of a captured image, the region being set and read as the read unit.

### BRIEF DESCRIPTION OF DRAWINGS

FIG. 1 is a block diagram illustrating a configuration of an example of an imaging device applicable to each embodiment of the present disclosure.

FIG. 2A is a schematic diagram illustrating an example of a hardware configuration of the imaging device according to each embodiment.

FIG. 2B is a schematic diagram illustrating an example of the hardware configuration of the imaging device according to each embodiment.

FIG. 3A is a diagram illustrating an example in which the imaging device according to each embodiment is formed by a stacked CIS having a two-layer structure.

FIG. 3B is a diagram illustrating an example in which the imaging device according to each embodiment is formed by a stacked CIS having a three-layer structure.

FIG. 4 is a block diagram illustrating a configuration of an example of a sensor unit applicable to each embodiment.

FIG. 5A is a schematic diagram for describing a rolling shutter method.

FIG. 5B is a schematic diagram for describing the rolling shutter method.

FIG. 5C is a schematic diagram for describing the rolling shutter method.

FIG. 6A is a schematic diagram for describing line skipping under the rolling shutter method.

FIG. 6B is a schematic diagram for describing line skipping under the rolling shutter method.

FIG. 6C is a schematic diagram for describing line skipping under the rolling shutter method.

FIG. 7A is a diagram schematically illustrating an example of another imaging method under the rolling shutter method.

FIG. 7B is a diagram schematically illustrating an example of another imaging method under the rolling shutter method.

FIG. 8A is a schematic diagram for describing a global shutter method.

FIG. 8B is a schematic diagram for describing the global shutter method.

FIG. 8C is a schematic diagram for describing the global shutter method.

FIG. 9A is a diagram schematically illustrating an example of a sampling pattern that can be formed under the global shutter method.

FIG. 9B is a diagram schematically illustrating an example of the sampling pattern that can be formed under the global shutter method.

FIG. 10 is a diagram schematically illustrating image recognition processing using a CNN.

FIG. 11 is a diagram schematically illustrating image recognition processing for obtaining a recognition result from a part of a recognition target image.

FIG. 12A is a diagram schematically illustrating an example of identification processing using a DNN in a case where time-series information is not used.

FIG. 12B is a diagram schematically illustrating an example of the identification processing using a DNN in a case where time-series information is not used.

FIG. 13A is a diagram schematically illustrating a first example of the identification processing using a DNN in a case where time-series information is used.

FIG. 13B is a diagram schematically illustrating the first example of the identification processing using a DNN in a case where time-series information is used.

FIG. 14A is a diagram schematically illustrating a second example of the identification processing using a DNN in a case where time-series information is used.

FIG. 14B is a diagram schematically illustrating the second example of the identification processing using a DNN in a case where time-series information is used.

FIG. 15A is a diagram for describing a relation between a driving speed of a frame and a reading amount of a pixel signal.

FIG. 15B is a diagram for describing a relation between a driving speed of a frame and a reading amount of a pixel signal.

FIG. 16 is a schematic diagram for schematically describing a recognition processing according to each embodiment of the present disclosure.

FIG. 17 is a functional block diagram of an example for describing a function of a control unit and a function of a recognition processing unit.

FIG. 18A is a block diagram illustrating a configuration of a reliability degree map generation unit.

FIG. 18B is a diagram schematically illustrating that the read count of line data varies in a manner that depends on an integration section (time).

FIG. 18C is a diagram illustrating an example in which a reading position of the line data is adaptively changed in accordance with a recognition result from a recognition processing execution unit.

FIG. 19 is a schematic diagram illustrating an example of the processing performed by the recognition processing unit in more detail.

FIG. 20 is a schematic diagram for describing reading processing in a reading unit.

FIG. 21 is a diagram illustrating a region that has been read on a line-by-line basis and a region that has not been read.

FIG. 22 is a diagram illustrating a region that has been read on a line-by-line basis from a left end to a right end and a region that has not been read.

FIG. 23 is a diagram schematically illustrating an example of reading on a line-by-line basis from the left end to the right end.

FIG. 24 is a diagram schematically illustrating a value of a reliability degree map in a case where a reading area changes in a recognition region.

FIG. 25 is a diagram schematically illustrating an example in which a reading range of line data is restricted.

FIG. 26 is a diagram schematically illustrating an example of an identification processing (recognition processing) using a DNN in a case where time-series information is not used.

FIG. 27A is a diagram illustrating an example in which one image is subsampled in a grid pattern.

FIG. 27B is a diagram illustrating an example in which one image is subsampled in a checkered pattern.

FIG. 28 is a diagram schematically illustrating a case where the reliability degree map is applied to a traffic system.

FIG. 29 is a flowchart illustrating a flow of a processing performed by a reliability degree calculation unit.

FIG. 30 is a schematic diagram illustrating a relation between a feature and a receptive field.

FIG. 31 is a diagram schematically illustrating a recognition region and a receptive field.

FIG. 32 is a diagram schematically illustrating a contribution degree to a feature in a recognition region.

FIG. 33 is a schematic diagram illustrating an image on which a recognition processing is performed on the basis of general semantic segmentation.

FIG. 34 is a block diagram of a reliability degree map generation unit according to a second embodiment.

FIG. 35 is a diagram schematically illustrating a relation between a recognition region and line data.

FIG. 36 is a block diagram of a reliability degree map generation unit according to a third embodiment.

FIG. 37 is a diagram schematically illustrating a relation with an exposure frequency of line data.

FIG. 38 is a block diagram of a reliability degree map generation unit according to a fourth embodiment.

FIG. 39 is a diagram schematically illustrating a relation with a dynamic range of line data.

FIG. 40 is a block diagram of a reliability degree map generation unit according to a fifth embodiment.

FIG. 41 is a diagram illustrating usage examples of information processing devices according to the first embodiment, each modification of the first embodiment, and a fifth embodiment.

FIG. 42 is a block diagram illustrating an example of a schematic configuration of a vehicle control system.

FIG. 43 is an explanatory diagram illustrating an example of installation positions of a vehicle exterior information detection unit and an imaging unit.

### MODE FOR CARRYING OUT THE INVENTION

Hereinafter, embodiments of an information processing device, an information processing system, an information processing method, and an information processing program will be described with reference to the drawings. Hereinafter, main components of the information processing device, the information processing system, the information processing method, and the information processing program will be mainly described, but the information processing device, the information processing system, the information processing method, and the information processing program may include components or functions that are not illustrated or described. The following description is not intended to exclude such components or functions that are not illustrated or described.

[1. Configuration Example According to Each Embodiment of Present Disclosure]

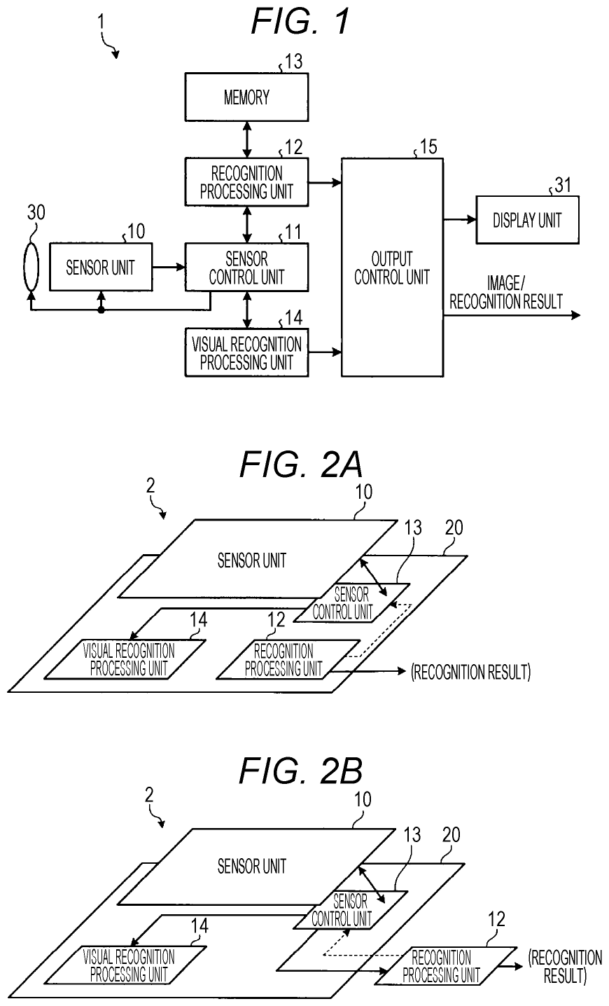

An overall configuration example of an information processing system according to each embodiment will be schematically described. FIG. 1 is a block diagram illustrating a configuration of an example of an information processing system 1. In FIG. 1, the information processing system 1 includes a sensor unit 10, a sensor control unit 11, a recognition processing unit 12, a memory 13, a visual recognition processing unit 14, and an output control unit 15. Each of the above-described units is, for example, a complementary metal oxide semiconductor (CMOS) image sensor (CIS) integrally formed using a CMOS. Note that the information processing system 1 is not limited to this example, and may be an optical sensor of another type such as an infrared optical sensor that captures an image with infrared light. Furthermore, the sensor control unit 11, the recognition processing unit 12, the memory 13, the visual recognition processing unit 14, and the output control unit 15 constitute an information processing device 2.

The sensor unit 10 outputs a pixel signal in accordance with light that impinges on a light receiving surface through an optical unit 30. More specifically, the sensor unit 10 includes a pixel array in which pixels each including at least one photoelectric conversion element are arranged in a matrix. The light receiving surface is formed by each pixel arranged in a matrix in the pixel array. The sensor unit 10 further includes a drive circuit that drives each pixel included in the pixel array, and a signal processing circuit that performs predetermined signal processing on a signal read from each pixel and outputs the signal as a pixel signal of each pixel. The sensor unit 10 outputs the pixel signal of each pixel included in a pixel region as digital image data.

Hereinafter, in the pixel array included in the sensor unit 10, a region in which active pixels that each generate the pixel signal are arranged is referred to as a frame. Frame image data is formed by pixel data based on the pixel signal output from each pixel included in the frame. Furthermore, each row of the array of pixels of the sensor unit 10 is referred to as a line, and line image data is formed by pixel data based on the pixel signal output from each pixel included in the line. Moreover, an operation in which the sensor unit 10 outputs the pixel signal in accordance with the light that impinges on the light receiving surface is referred to as imaging. The sensor unit 10 controls an exposure at the time of imaging and a gain (analog gain) of the pixel signal in accordance with an imaging control signal supplied from the sensor control unit 11 to be described later.

The sensor control unit 11 includes, for example, a microprocessor, controls reading of the pixel data from the sensor unit 10, and outputs the pixel data based on the pixel signal read from each pixel included in the frame. The pixel data output from the sensor control unit 11 is supplied to the recognition processing unit 12 and the visual recognition processing unit 14.

Furthermore, the sensor control unit 11 generates the imaging control signal for controlling imaging in the sensor unit 10. The sensor control unit 11 generates the imaging control signal in accordance with, for example, instructions from the recognition processing unit 12 and the visual recognition processing unit 14 to be described later. The imaging control signal includes information indicating the exposure and the analog gain at the time of imaging in the sensor unit 10 described above. The imaging control signal further includes a control signal (a vertical synchronization signal, a horizontal synchronization signal, or the like.) that is used by the sensor unit 10 to perform an imaging operation. The sensor control unit 11 supplies the imaging control signal thus generated to the sensor unit 10.

The optical unit 30 is configured to cause light from a subject to impinge on the light receiving surface of the sensor unit 10, and is disposed at a position corresponding to the sensor unit 10, for example. The optical unit 30 includes, for example, a plurality of lenses, a diaphragm mechanism configured to adjust a size of an opening with respect to the incident light, and a focus mechanism configured to adjust a focal point of light that impinges on the light receiving surface. The optical unit 30 may further include a shutter mechanism (mechanical shutter) that adjusts a time during which light is incident on the light receiving surface. The diaphragm mechanism, the focus mechanism, and the shutter mechanism included in the optical unit 30 can be controlled by, for example, the sensor control unit 11. Alternatively, the diaphragm and the focus in the optical unit 30 can be controlled from the outside of the information processing system 1. Furthermore, the optical unit 30 can be integrated with the information processing system 1.

The recognition processing unit 12 performs, on the basis of the pixel data supplied from the sensor control unit 11, processing of recognizing an object included in the image based on the pixel data. In the present disclosure, for example, the recognition processing unit 12 serving as a machine learning unit that performs the recognition processing using a deep neural network (DNN) is implemented by, for example, a digital signal processor (DSP) that load and execute a program corresponding to a learning model learned in advance using training data and stored in the memory 13. The recognition processing unit 12 can instruct the sensor control unit 11 to read, from the sensor unit 10, pixel data necessary for the recognition processing. A recognition result from the recognition processing unit 12 is supplied to the output control unit 15.

The visual recognition processing unit 14 performs processing of obtaining an image that is easy for human to recognize supplied from the sensor control unit 11, and outputs image data including a group of pixel data, for example. For example, the visual recognition processing unit 14 is implemented by an image signal processor (ISP) that loads and executes a program prestored in a memory (not illustrated).

For example, in a case where a color filter is provided for each pixel included in the sensor unit 10, and the pixel data contains color information of red (R), green (G), and blue (B), the visual recognition processing unit 14 can perform demosaicing processing, white balance processing, and the like. Furthermore, the visual recognition processing unit 14 can instruct the sensor control unit 11 to read pixel data necessary for the visual recognition processing from the sensor unit 10. The image data obtained by performing the image processing on the pixel data by the visual recognition processing unit 14 is supplied to the output control unit 15.

The output control unit 15 includes, for example, a microprocessor, and outputs either or both of the recognition result supplied from the recognition processing unit 12 and the image data supplied as the visual recognition processing result from the visual recognition processing unit 14 to the outside of the information processing system 1. The output control unit can output the image data to, for example, a display unit 31 including a display device. This allows the user to visually recognize the image data displayed by the display unit 31. Note that the display unit 31 may be built in the information processing system 1 or may be separate from the information processing system 1.

FIGS. 2A and 2B are schematic diagrams each illustrating an example of a hardware configuration of the information processing system 1 according to each embodiment. FIG. 2A illustrates an example where the sensor unit 10, the sensor control unit 11, the recognition processing unit 12, the memory 13, the visual recognition processing unit 14, and the output control unit 15 among the components illustrated in FIG. 1 are mounted on a single chip 2. Note that, in FIG. 2A, neither the memory 13 nor the output control unit 15 is illustrated for the sake of simplicity.

With the configuration illustrated in FIG. 2A, the recognition result from the recognition processing unit 12 is output to the outside of the chip 2 via the output control unit 15 (not illustrated). Furthermore, with the configuration illustrated in FIG. 2A, the recognition processing unit 12 can acquire pixel data to be used for recognition from the sensor control unit 11 via an interface inside the chip 2.

FIG. 2B illustrates an example where the sensor unit 10, the sensor control unit 11, the visual recognition processing unit 14, and the output control unit 15 among the components illustrated in FIG. 1 are mounted on the single chip 2, and the recognition processing unit 12 and the memory 13 (not illustrated) are installed outside the chip 2. Also in FIG. 2B, as in FIG. 2A described above, neither the memory 13 nor the output control unit 15 is illustrated for the sake of simplicity.

With the configuration illustrated in FIG. 2B, the recognition processing unit 12 acquires pixel data to be used for recognition via an interface responsible for performing chip-to-chip communication. Furthermore, in FIG. 2B, the recognition result is directly output from the recognition processing unit 12 to the outside, but how to output the recognition result is not limited to this example. That is, with the configuration illustrated in FIG. 2B, the recognition processing unit 12 may return the recognition result to the chip 2 to cause the output control unit 15 (not illustrated) mounted on the chip 2 to output the recognition result.

With the configuration illustrated in FIG. 2A, the recognition processing unit 12 is mounted on the chip 2 together with the sensor control unit 11, so as to allow high-speed communication between the recognition processing unit 12 and the sensor control unit 11 via an interface inside the chip 2. On the other hand, with the configuration illustrated in FIG. 2A, the recognition processing unit 12 cannot be replaced, and it is therefore difficult to change the recognition processing. On the other hand, with the configuration illustrated in FIG. 2B, since the recognition processing unit 12 is provided outside the chip 2, the communication between the recognition processing unit 12 and the sensor control unit 11 needs to be performed via an interface between chips. This makes the communication between the recognition processing unit 12 and the sensor control unit 11 slow as compared with the configuration illustrated in FIG. 2A, and there is a possibility that a delay occurs in control. On the other hand, the recognition processing unit 12 can be easily replaced, so that various types of recognition processing can be implemented.

Hereinafter, unless otherwise specified, it is assumed that the information processing system 1 has a configuration in which the sensor unit 10, the sensor control unit 11, the recognition processing unit 12, the memory 13, the visual recognition processing unit 14, and the output control unit 15 are mounted on the single chip 2 as illustrated in FIG. 2A.

With the configuration illustrated in FIG. 2A described above, the information processing system 1 can be implemented on one board. Alternatively, the information processing system 1 may be a stacked CIS in which a plurality of semiconductor chips is stacked into a single body.

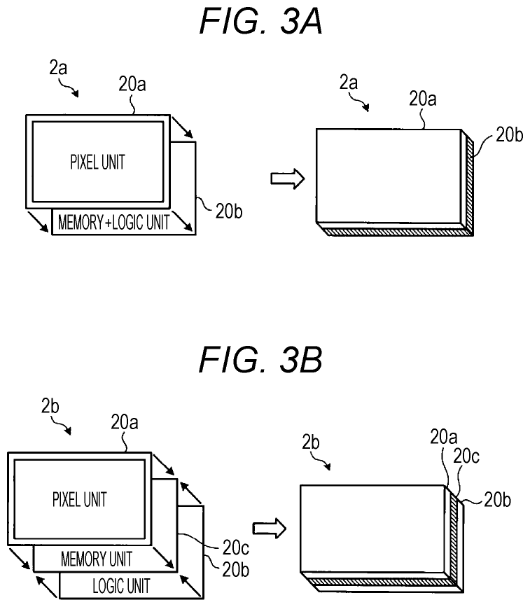

As an example, the information processing system 1 can be implemented with a two-layer structure in which semiconductor chips are stacked in two layers. FIG. 3A is a diagram illustrating an example in which the information processing system 1 according to each embodiment is implemented by a stacked CIS having a two-layer structure. With the structure illustrated in FIG. 3A, a pixel unit 20a is implemented on a semiconductor chip of the first layer, and a memory+logic unit 20b is implemented on a semiconductor chip of the second layer. The pixel unit 20a includes at least the pixel array in the sensor unit 10. The memory+logic unit 20b includes, for example, the sensor control unit 11, the recognition processing unit 12, the memory 13, the visual recognition processing unit 14, the output control unit 15, and the interface responsible for performing communication between the information processing system 1 and the outside. The memory+logic unit 20b further includes a part or all of the drive circuit that drives the pixel array in the sensor unit 10. Furthermore, although not illustrated, the memory+logic unit 20b can further include, for example, a memory that is used for the visual recognition processing unit 14 to process image data.

As illustrated on the right side of FIG. 3A, the information processing system 1 is configured as a single solid state image sensor obtained by bonding the semiconductor chip of the first layer and the semiconductor chip of the second layer together with both the semiconductor chips in electrical contact with each other.

Alternatively, the information processing system 1 can be implemented with a three-layer structure in which semiconductor chips are stacked in three layers. FIG. 3B is a diagram illustrating an example in which the information processing system 1 according to each embodiment is implemented by a stacked CIS having a three-layer structure. With the structure illustrated in FIG. 3B, the pixel unit 20a is implemented on the semiconductor chip of the first layer, a memory unit 20c is implemented on the semiconductor chip of the second layer, and the logic unit 20b is implemented on the semiconductor chip of the third layer. In this case, the logic unit 20b includes, for example, the sensor control unit 11, the recognition processing unit 12, the visual recognition processing unit 14, the output control unit 15, and the interface responsible for performing communication between the information processing system 1 and the outside. Furthermore, the memory unit 20c can include the memory 13 and, for example, a memory that is used for the visual recognition processing unit 14 to process image data. The memory 13 may be included in the logic unit 20b.

As illustrated on the right side of FIG. 3B, the information processing system 1 is configured as a single solid state image sensor obtained by bonding the semiconductor chip of the first layer, the semiconductor chip of the second layer, and the semiconductor chip of the third layer together with all the semiconductor chip in electrical contact with each other.

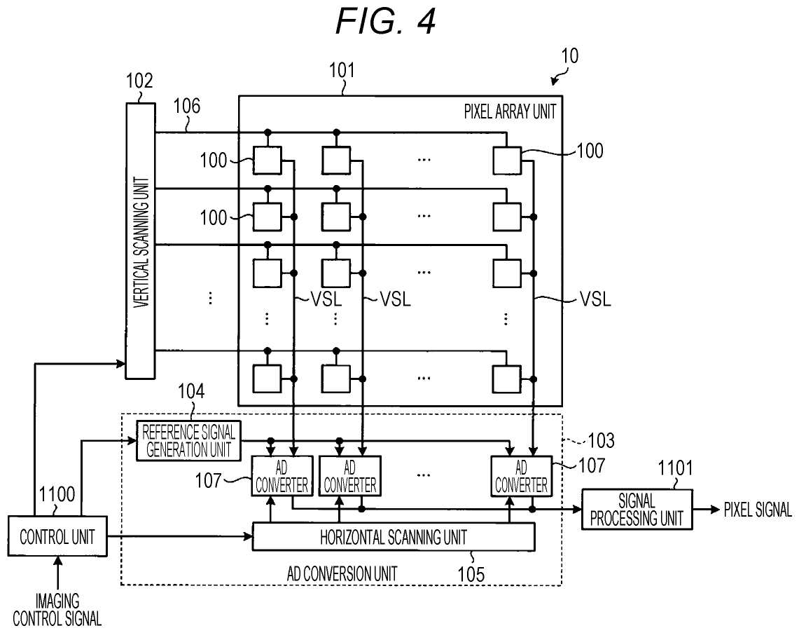

FIG. 4 is a block diagram illustrating a configuration of an example of the sensor unit 10 applicable to each embodiment. In FIG. 4, the sensor unit 10 includes a pixel array unit 101, a vertical scanning unit 102, an analog to digital (AD) conversion unit 103, a pixel signal line 106, a vertical signal line VSL, a control unit 1100, and a signal processing unit 1101. Note that, in FIG. 4, the control unit 1100 and the signal processing unit 1101 can also be included in the sensor control unit 11 illustrated in FIG. 1, for example.

The pixel array unit 101 includes a plurality of pixel circuits 100 each including, for example, a photoelectric conversion element including a photodiode that performs photoelectric conversion on received light, and a circuit that reads an electric charge from the photoelectric conversion element. In the pixel array unit 101, the plurality of pixel circuits 100 is arranged in a matrix in a horizontal direction (row direction) and a vertical direction (column direction). In the pixel array unit 101, an arrangement of the pixel circuits 100 in the row direction is referred to as a line. For example, in a case where an image of one frame is formed with 1920 pixels*1080 lines, the pixel array unit 101 includes at least 1080 lines each including at least 1920 pixel circuits 100. An image (image data) of one frame is formed by pixel signals read from the pixel circuits 100 included in the frame.

Hereinafter, the operation of reading the pixel signal from each pixel circuit 100 included in the frame in the sensor unit 10 will be referred to as reading the pixel from the frame as needed. Furthermore, the operation of reading the pixel signal from each pixel circuit 100 in each line included in the frame will be referred to as, for example, reading the line as needed.

Furthermore, in the pixel array unit 101, the pixel signal line 106 is provided for each row to connect to each pixel circuit 100, and the vertical signal line VSL is provided for each column to connect to each pixel circuit 100. An end of the pixel signal line 106 that is not connected to the pixel array unit 101 is connected to the vertical scanning unit 102. The vertical scanning unit 102 transmits, under the control of the control unit 1100 to be described later, a control signal such as a drive pulse for reading the pixel signal from each pixel to the pixel array unit 101 over the pixel signal line 106. An end of the vertical signal line VSL that is not connected to the pixel array unit 101 is connected to the AD conversion unit 103. The pixel signal read from each pixel is transmitted to the AD conversion unit 103 over the vertical signal line VSL.

How to control the reading of the pixel signal from each pixel circuit 100 will be schematically described. The reading of the pixel signal from each pixel circuit 100 is performed by transferring the electric charge stored in the photoelectric conversion element by exposure to a floating diffusion layer (FD) and converting the electric charge transferred to floating diffusion into a voltage. The voltage obtained by converting the electric charge in the floating diffusion layer is output to the vertical signal line VSL via an amplifier.

More specifically, in the pixel circuit 100, during exposure, the photoelectric conversion element and the floating diffusion layer are in an off (open) state, so that the electric charge generated in accordance with incident light by photoelectric conversion is stored in the photoelectric conversion element. After the end of exposure, the floating diffusion layer and the vertical signal line VSL are connected in accordance with a selection signal supplied over the pixel signal line 106. Further, the floating diffusion layer is connected to a feed line of a power supply voltage VDD or a black level voltage for a short period of time in accordance with a reset pulse supplied over the pixel signal line 106, and the floating diffusion layer is reset accordingly. A voltage (referred to as a voltage A) at the reset level of the floating diffusion layer is output to the vertical signal line VSL. Thereafter, the photoelectric conversion element and the floating diffusion layer are brought into an on (closed) state in accordance with a transfer pulse supplied over the pixel signal line 106, so as to transfer the electric charge stored in the photoelectric conversion element to the floating diffusion layer. A voltage (referred to as a voltage B) corresponding to the amount of electric charge of the floating diffusion layer is output to the vertical signal line VSL.

The AD conversion unit 103 includes an AD converter 107 provided for each vertical signal line VSL, a reference signal generation unit 104, and a horizontal scanning unit 105. The AD converter 107 is a column AD converter that performs AD conversion processing on each column of the pixel array unit 101. The AD converter 107 performs AD conversion processing on the pixel signal supplied from each pixel circuit 100 over the vertical signal line VSL to generate two digital values (values corresponding to the voltage A and the voltage B) for correlated double sampling (CDS) processing that is performed to reduce noise.

The AD converter 107 supplies the two digital values thus generated to the signal processing unit 1101. The signal processing unit 1101 performs the CDS processing on the basis of the two digital values supplied from the AD converter 107 to generate a digital pixel signal (pixel data). The pixel data generated by the signal processing unit 1101 is output to the outside of the sensor unit 10.

The reference signal generation unit 104 generates, on the basis of the control signal input from the control unit 1100, a ramp signal that is used for each AD converter 107 to convert the pixel signal into two digital values, the ramp signal serving as a reference signal. The ramp signal is a signal whose level (voltage value) decreases linearly with respect to time, or a signal whose level decreases stepwise. The reference signal generation unit 104 supplies the ramp signal thus generated to each AD converter 107. The reference signal generation unit 104 includes, for example, a digital-to-analog converter (DAC) or the like.

When the ramp signal whose voltage decreases stepwise at a predetermined gradient is supplied from the reference signal generation unit 104, a counter start to count in accordance with a clock signal. A comparator compares the voltage of the pixel signal supplied from the vertical signal line VSL with the voltage of the ramp signal, and stops the counter from counting at timing when the voltage of the ramp signal exceeds the voltage of the pixel signal. The AD converter 107 converts an analog pixel signal into a digital value by outputting a value corresponding to the count value when the counting is stopped.

The AD converter 107 supplies the two digital values thus generated to the signal processing unit 1101. The signal processing unit 1101 performs the CDS processing on the basis of the two digital values supplied from the AD converter 107 to generate a digital pixel signal (pixel data). The digital pixel signal generated by the signal processing unit 1101 is output to the outside of the sensor unit 10.

The horizontal scanning unit 105 performs, under the control of the control unit 1100, selective scanning to select each AD converter 107 in a predetermined order, so as to sequentially output each digital value temporarily held by each AD converter 107 to the signal processing unit 1101. The horizontal scanning unit 105 includes, for example, a shift register, an address decoder, or the like.

The control unit 1100 performs drive control on the vertical scanning unit 102, the AD conversion unit 103, the reference signal generation unit 104, the horizontal scanning unit 105, and the like in accordance with the imaging control signal supplied from the sensor control unit 11. The control unit 1100 generates various drive signals, on the basis of which the vertical scanning unit 102, the AD conversion unit 103, the reference signal generation unit 104, and the horizontal scanning unit 105 operates. The control unit 1100 generates a control signal that is supplied from the vertical scanning unit 102 to each pixel circuit 100 over the pixel signal line 106 on the basis of, for example, the vertical synchronization signal or an external trigger signal included in the imaging control signal, and the horizontal synchronization signal. The control unit 1100 supplies the control signal thus generated to the vertical scanning unit 102.

Furthermore, the control unit 1100 outputs, for example, information indicating the analog gain included in the imaging control signal supplied from the sensor control unit 11 to the AD conversion unit 103. The AD conversion unit 103 controls, in accordance with the information indicating the analog gain, a gain of the pixel signal input to each AD converter 107 included in the AD conversion unit 103 over the vertical signal line VSL.

The vertical scanning unit 102 supplies, on the basis of the control signal supplied from the control unit 1100, various signals including the drive pulse to the pixel signal line 106 of the selected pixel row of the pixel array unit 101, that is, to each pixel circuit 100 per line, so as to cause each pixel circuit 100 to output the pixel signal to the vertical signal line VSL. The vertical scanning unit 102 includes, for example, a shift register, an address decoder, or the like. Furthermore, the vertical scanning unit 102 controls the exposure of each pixel circuit 100 in accordance with information indicating exposure supplied from the control unit 1100.

The sensor unit 10 configured as described above is a column AD type complementary metal oxide semiconductor (CMOS) image sensor in which the AD converter 107 is disposed for each column.

[2. Example of Existing Technology Applicable to Present Disclosure]

Prior to describing each embodiment according to the present disclosure, an existing technology applicable to the present disclosure will be schematically described for easy understanding.

(2-1. Outline of Rolling Shutter)

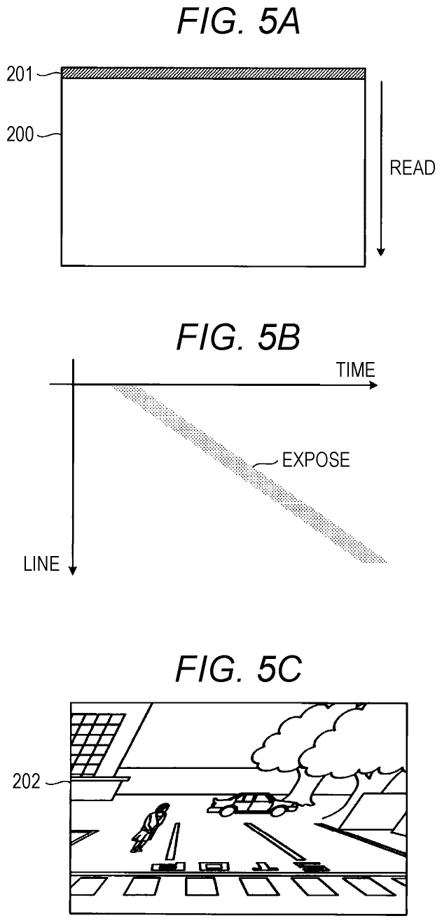

As an imaging method applied to imaging by the pixel array unit 101, a rolling shutter (RS) method and a global shutter (GS) method are known. First, the rolling shutter method will be schematically described. FIGS. 5A, 5B, and 5C are schematic diagrams for describing the rolling shutter method. Under the rolling shutter method, as illustrated in FIG. 5A, imaging is sequentially performed on a line-by-line basis from a line 201 at an upper end of a frame 200, for example.

Note that “imaging” has been described above to refer to the operation in which the sensor unit 10 outputs the pixel signal in accordance with the light incident on the light receiving surface. More specifically, “imaging” refers to a series of operations from the exposure of the pixel to the transfer of the pixel signal based on the electric charge stored by the exposure in the photoelectric conversion element included in the pixel to the sensor control unit 11. Furthermore, as described above, the frame refers to a region in which active pixel circuits 100 that each generate the pixel signal are arranged in the pixel array unit 101.

For example, with the configuration illustrated in FIG. 4, the pixel circuits 100 included in one line are simultaneously exposed. After the end of the exposure, the pixel circuits 100 included in the line simultaneously transfer the pixel signal based on the electrical charge stored by the exposure over their respective vertical signal lines VSL. Sequentially performing the above-described operation on a line-by-line basis achieves imaging by rolling shutter.

FIG. 5B schematically illustrates an example of a relation between imaging and time under the rolling shutter method. In FIG. 5B, the vertical axis represents a line position, and the horizontal axis represents time. Under the rolling shutter method, the exposure is performed on a line-by-line basis, so that, as illustrated in FIG. 5B, exposure timing of each line is shifted as the line position changes. Therefore, for example, in a case where a positional relation between the information processing system 1 and the subject in the horizontal direction rapidly changes, distortion is produced in the image obtained by capturing the frame 200 as illustrated in FIG. 5C. In the example illustrated in FIG. 5C, an image 202 corresponding to the frame 200 becomes tilted at an angle corresponding to a speed and direction of change in the positional relation between the information processing system 1 and the subject in the horizontal direction.

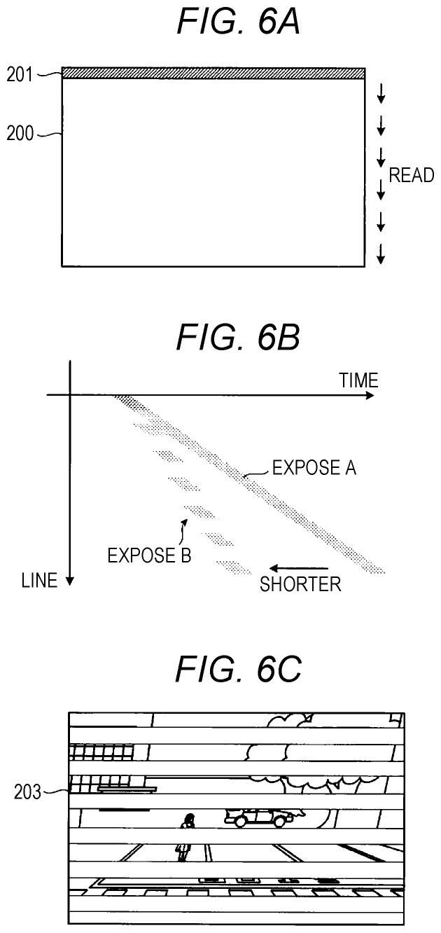

Under the rolling shutter method, it is also possible to perform imaging with some lines skipped. FIGS. 6A, 6B, and 6C are schematic diagrams for describing line skipping under the rolling shutter method. As illustrated in FIG. 6A, as in the example illustrated in FIG. 5A described above, imaging is performed on a line-by-line basis from the line 201 at the upper end of the frame 200 toward a lower end of the frame 200. At this time, imaging is performed while skipping every predetermined number of lines.

Here, for the description, it is assumed that imaging is performed every other line, that is, while skipping every other line. That is, after the n-th line is imaged, the (n+2)-th line is imaged. At this time, it is assumed that a time from the imaging of the n-th line to the imaging of the (n+2)-th line is equal to a time from the imaging of the n-th line to the imaging of the (n+1)-th line in a case where skipping is not performed.

FIG. 6B schematically illustrates an example of a relation between imaging and time in a case where one-line skipping is performed under the rolling shutter method. In FIG. 6B, the vertical axis represents a line position, and the horizontal axis represents time. In FIG. 6B, exposure A corresponds to the exposure in FIG. 5B in which no skipping is performed, and exposure B indicates exposure in a case where one-line skipping is performed. The exposure B shows that performing line skipping makes it possible to reduce a difference in exposure timing at the same line position as compared with a case where no line skipping is performed. Therefore, as illustrated as an image 203 in FIG. 6C, distortion produced along the direction in the image obtained by capturing the frame 200 is tilted is smaller than distortion produced in a case where the line skipping illustrated in FIG. 5C is not performed. On the other hand, a case where line skipping is performed makes the image resolution lower than in a case where no line skipping is performed.

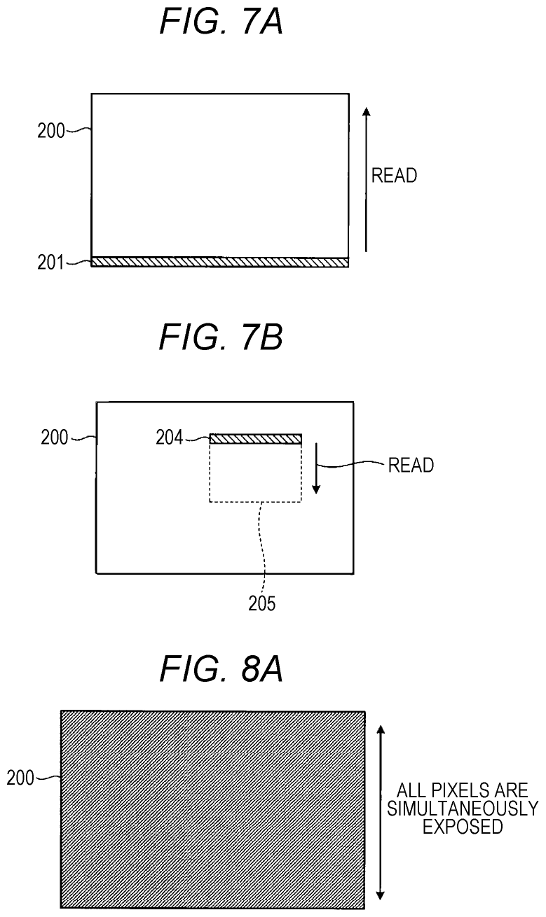

A description has been given above of an example in which imaging is performed on a line-by-line basis from the upper end to the lower end of the frame 200 under the rolling shutter method, but how to perform imaging is not limited to this example. FIGS. 7A and 7B are diagrams schematically illustrating an example of another imaging method under the rolling shutter method. For example, as illustrated in FIG. 7A, under the rolling shutter method, imaging can be performed on a line-by-line basis from the lower end to the upper end of the frame 200. In this case, the horizontal distortion of the image 202 becomes opposite in direction to a case where the imaging is performed on a line-by-line basis from the upper end to the lower end of the frame 200.

Furthermore, for example, it is also possible to set a range of the vertical signal line VSL over which the pixel signal is transferred, so as to allow a part of the line to be selectively read. Moreover, it is also possible to set the line used for imaging and the vertical signal line VSL used for transferring the pixel signal, so as to allow the first imaging line and the last imaging line to be set other than the upper end and the lower end of the frame 200. FIG. 7B schematically illustrates an example in which a rectangular region 205 that is less in width and height than the frame 200 is set as an imaging range. In the example illustrated in FIG. 7B, imaging is performed on a line-by-line basis from a line 204 at the upper end of the region 205 toward the lower end of the region 205.

(2-2. Overview of Global Shutter)

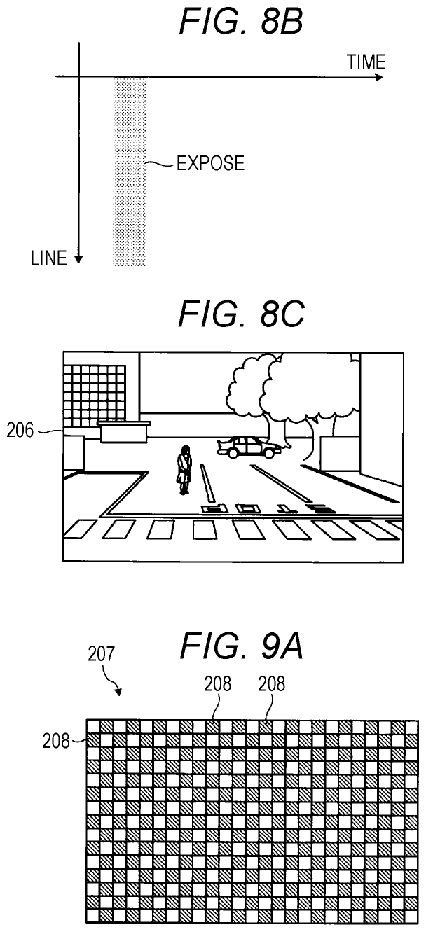

Next, as an imaging method applied to imaging by the pixel array unit 101, a global shutter (GS) method will be schematically described. FIGS. 8A, 8B, and 8C are schematic diagrams for describing the global shutter method. Under the global shutter method, as illustrated in FIG. 8A, all the pixel circuits 100 included in the frame 200 are simultaneously exposed.

In a case where the global shutter method is applied to the configuration illustrated in FIG. 4, a configuration is conceivable as an example in which a capacitor is further provided between the photoelectric conversion element and the FD in each pixel circuit 100. Then, a first switch is provided between the photoelectric conversion element and the capacitor, and a second switch is provided between the capacitor and the floating diffusion layer, and the opening and closing of each of the first and second switches is controlled in accordance with a pulse supplied over the pixel signal line 106.

In such a configuration, the first and second switches in all the pixel circuits 100 included in the frame 200 are in the open state during exposure, and the end of the exposure brings the first switch into the closed state from the open state to transfer the electric charge from the photoelectric conversion element to the capacitor. Thereafter, the capacitor is regarded as a photoelectric conversion element, and the electric charge is read from the capacitor in a similar manner to the reading operation under the rolling shutter method described above. This allows simultaneous exposure of all the pixel circuits 100 included in the frame 200.

FIG. 8B schematically illustrates an example of a relation between imaging and time under the global shutter method. In FIG. 8B, the vertical axis represents a line position, and the horizontal axis represents time. Under the global shutter method, all the pixel circuits 100 included in the frame 200 are simultaneously exposed, so that the exposure timing can be the same among the lines as illustrated in FIG. 8B. Therefore, for example, even in a case where a positional relation between the information processing system 1 and the subject in the horizontal direction rapidly changes, no distortion is produced in an image 206 obtained by capturing the frame 200 as illustrated in FIG. 8C.

The global shutter method can ensure that all the pixel circuits 100 included in the frame 200 are simultaneously exposed. Therefore, controlling the timing of each pulse supplied over the pixel signal line 106 of each line and the timing of transfer over each vertical signal line VSL makes it possible to achieve sampling (reading of pixel signals) in various patterns.

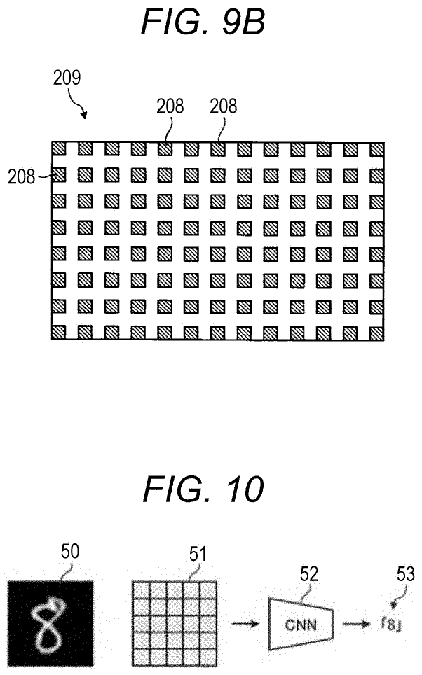

FIGS. 9A and 9B are diagrams schematically illustrating an example of a sampling pattern that can be achieved under the global shutter method. FIG. 9A illustrates an example in which samples 208 from which the pixel signals are read are extracted in a checkered pattern from the pixel circuits 100 that are included in the frame 200 and are arranged in a matrix. Furthermore, FIG. 9B illustrates an example in which the samples 208 from which pixel signals are read are extracted in a grid pattern from the pixel circuits 100. Furthermore, it is also possible to perform, even under the global shutter method, imaging on a line-by-line basis in a similar manner to the rolling shutter method described above.

(2-3. DNN)

Next, recognition processing using a deep neural network (DNN) applicable to each embodiment will be schematically described. In each embodiment, recognition processing on image data is performed using a convolutional neural network (CNN) and a recurrent neural network (RNN) as the DNN. Hereinafter, the “recognition processing on image data” is referred to as, for example, “image recognition processing” as needed.

(2-3-1. Overview of CNN)

First, the CNN will be schematically described. In general, image recognition processing using the CNN is performed on the basis of image information based on pixels arranged in a matrix, for example. FIG. 10 is a diagram schematically illustrating the image recognition processing using the CNN. Processing using a CNN 52 that has been learned in a predetermined manner is performed on pixel information 51 of an image 50′ showing a written digit “8” that is a recognition target object. As a result, the digit “8” is recognized as a recognition result 53.

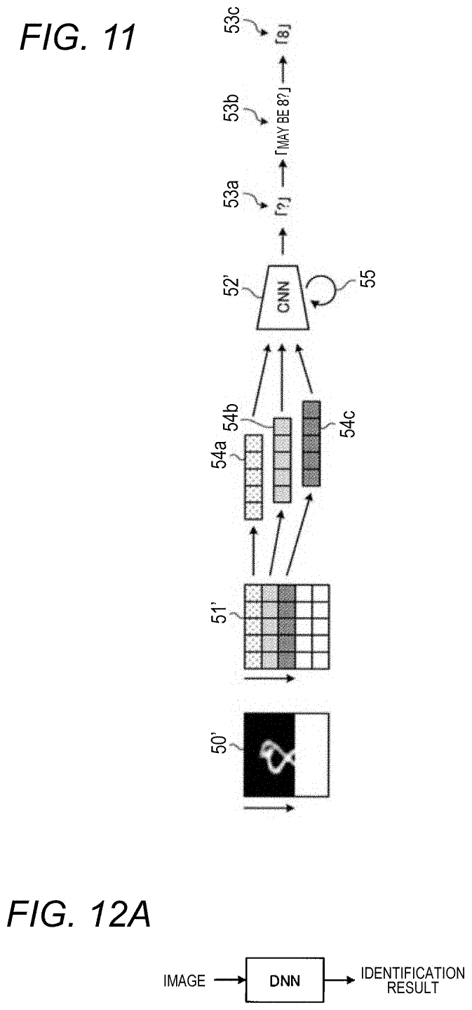

On the other hand, it is also possible to obtain a recognition result from a part of the recognition target image by performing processing using the CNN on the basis of each line image. FIG. 11 is a diagram schematically illustrating image recognition processing for obtaining a recognition result from a part of the recognition target image. In FIG. 11, the image 50′ is obtained by acquiring partially, that is, on a line-by-line basis, the digit “8” that is a recognition target object. For example, pixel information 54a, 54b, and 54c for each line constituting pixel information 51′ of the image 50′ is sequentially processed using the CNN 52′ learned in a predetermined manner.

For example, it is assumed that a recognition result 53a of the recognition processing using the CNN 52′ performed on the pixel information 54a of the first line is not a valid recognition result. Here, the valid recognition result refers to, for example, a recognition result showing that a score indicating a reliability degree of the recognition result is greater than or equal to a predetermined value.

Note that the reliability degree according to the present embodiment means an evaluation value indicating how trustworthy the recognition result [I] output by the DNN is. For example, a range of the reliability degree is from 0.0 to 1.0, and the closer the numerical value is to 1.0, the less the number of similar candidates close in score to the recognition result [T]. On the other hand, the closer the numerical value is to 0, the more the number of similar candidates close in score to the recognition result [T].

The CNN 52′ performs updating 55 of an internal state on the basis of the recognition result 53a. Next, recognition processing is performed on the pixel information 54b of the second line using the CNN 52′ whose internal state has been subjected to the updating 55 in accordance with the last recognition result 53a. In FIG. 11, as a result, a recognition result 53b indicating that the recognition target digit is either “8” or “9” is obtained. The updating 55 of internal information of the CNN 52′ is further performed on the basis of the recognition result 53b. Next, recognition processing is performed on the pixel information 54c of the third line using the CNN 52′ whose internal state has been subjected to the updating 55 in accordance with the last recognition result 53b. In FIG. 11, as a result, the recognition target digit is narrowed down to “8” out of “8” and “9”.

Here, in the recognition processing illustrated in FIG. 11, the internal state of the CNN is updated using the result of the last recognition processing, and the recognition processing is performed using the pixel information of the line adjacent to the line subjected to the last recognition processing using the CNN whose internal state has been updated. That is, the recognition processing illustrated in FIG. 11 is performed on the image on a line-by-line basis while updating the internal state of the CNN on the basis of the last recognition result. Therefore, the recognition processing illustrated in FIG. 11 is processing recursively performed on a line-by-line basis, and can be considered to have a structure corresponding to the RNN.

(2-3-2. Overview of RNN)

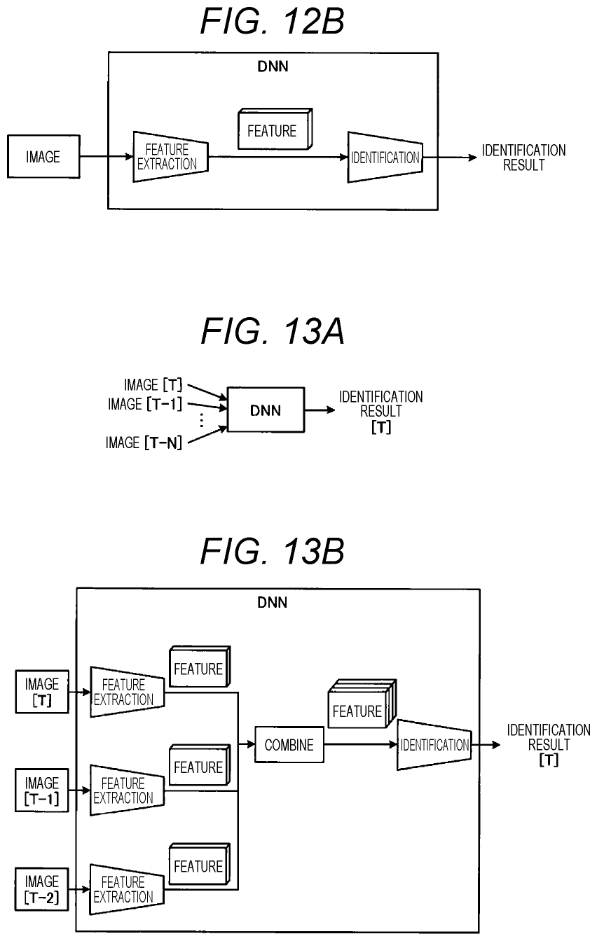

Next, the RNN will be schematically described. FIGS. 12A and 12B are diagrams schematically illustrating an example of identification processing (recognition processing) performed using the DNN in a case where time-series information is not used. In this case, as illustrated in FIG. 12A, one image is input to the DNN. In the DNN, identification processing is performed on the input image, and an identification result is output.

FIG. 12B is a diagram for describing the processing illustrated in FIG. 12A in more detail. As illustrated in FIG. 12B, the DNN performs feature extraction processing and identification processing. The DNN performs the feature extraction processing to extract a feature from the input image. Furthermore, the DNN performs the identification processing on the extracted feature to obtain an identification result.

FIGS. 13A and 13B are diagrams schematically illustrating a first example of the identification processing using the DNN in a case where time-series information is used. In the example illustrated in FIGS. 13A and 13B, a fixed number of pieces of past time-series information is subjected to the identification processing using the DNN. In the example illustrated in FIG. 13A, an image [T] at a time T, an image [T−1] at a time T−1 before the time T, and an image [T−2] at a time T−2 before the time T−1 are input to the DNN. In the DNN, the identification processing is performed on each of the input images [T], [T−1], and [T−2] to obtain an identification result [T] at a time T. A reliability degree is given to the identification result [T].

FIG. 13B is a diagram for describing the processing illustrated in FIG. 13A in more detail. As illustrated in FIG. 13B, in the DNN, the feature extraction processing described above with reference to FIG. 12B is performed, on a one-to-one basis, on each of the input images [T], [T−1], and [T−2] to extract features corresponding to the images [T], [T−1], and [T−2]. In the DNN, the respective features obtained on the basis of the images [T], [T−1], and [T−2] are combined, and the identification processing is performed on the combined feature to obtain the identification result [T] at the time T. A reliability degree is given to the identification result [T].

Under the method illustrated in FIGS. 13A and 13B, a plurality of components for performing feature extraction is required, and a component for performing feature extraction in accordance with the number of available past images is required, so that there is a possibility that the configuration of the DNN becomes large.

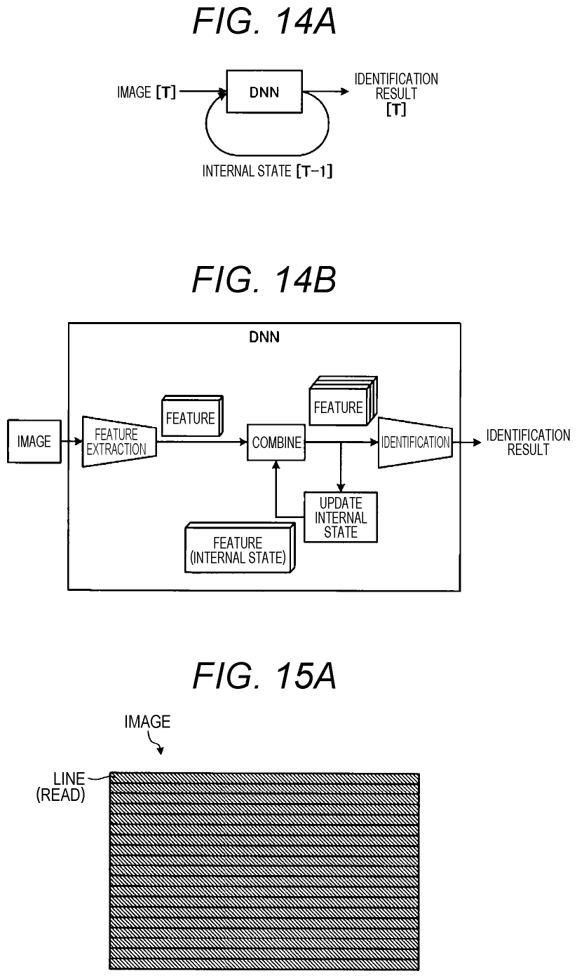

FIGS. 14A and 14B are diagrams schematically illustrating a second example of the identification processing using the DNN in a case where time-series information is used. In the example illustrated in FIG. 14A, an image [T] at a time T is input to the DNN whose internal state has been updated to a state at a time T−1, and an identification result [T] at the time T is obtained. A reliability degree is given to the identification result [T].

FIG. 14B is a diagram for describing the processing illustrated in FIG. 14A in more detail. As illustrated in FIG. 14B, in the DNN, the feature extraction processing described above with reference to FIG. 12B is performed on the input image [T] at the time T, and a feature corresponding to the image [T] is extracted. In the DNN, the internal state is updated using an image before the time T, and the feature related to the updated internal state is stored. The stored feature related to the internal information and the feature of the image [T] are combined, and the identification processing is performed on the combined feature.

The identification processing illustrated in FIGS. 14A and 14B is performed using, for example, the DNN whose internal state has been updated using the last identification result, and is thus recursive processing. Such a DNN that performs recursive processing is referred to as a recurrent neural network (RNN). The identification processing using the RNN is generally used for moving image recognition or the like, and, for example, the internal state of the DNN is sequentially updated by frame images updated in time series, thereby allowing an increase in identification accuracy.

In the present disclosure, the RNN is applied to a structure using the rolling shutter method. That is, under the rolling shutter method, reading of pixel signals is performed on a line-by-line basis. Therefore, the pixel signals read on a line-by-line basis is applied to the RNN as time-series information. As a result, the identification processing based on the plurality of lines can be performed with a small-scale configuration as compared with a configuration using the CNN (see FIG. 13B). Alternatively, the RNN may be applied to a structure using the global shutter method. In this case, for example, it is conceivable that adjacent lines are regarded as time-series information.

(2-4. Driving Speed)

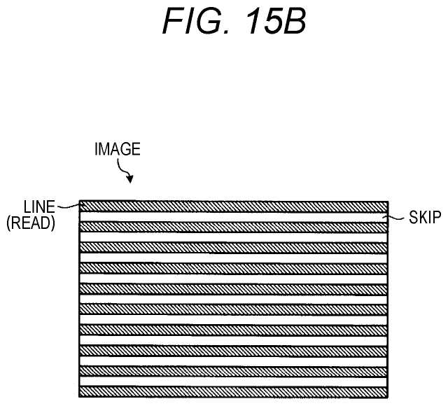

Next, a relation between a driving speed of the frame and a reading amount of the pixel signal will be described with reference to FIGS. 15A and 15B. FIG. 15A is a diagram illustrating an example in which all lines in an image are read. Here, it is assumed that the resolution of an image to be subjected to recognition processing is 640 pixels in the horizontal direction*480 pixels (480 lines) in the vertical direction. In this case, driving at a driving speed of 14400 [line/second] allows output at 30 [frame per second (fps)].

Next, consider a case where imaging is performed with line skipping. For example, as illustrated in FIG. 15B, it is assumed that imaging is performed while skipping every other line, that is, imaging is performed with ½ skipping. As a first example of the ½ skipping, in a case of driving at a driving speed of 14400 [lines/second] in the same manner as described above, the number of lines to be read from the image becomes ½, so that the resolution decreases, but it is possible to output at 60 [fps] that is twice the speed in a case where no skipping is performed, allowing an increase in the frame rate. As a second example of the ½ skipping, in a case of driving at a driving speed of 7200 [fps] that is a half of the driving speed in the first example, the frame rate is 30 [fps] as in a case where no skipping is performed, but power consumption can be reduced.

When the line image is read, whether no skipping is performed, skipping is performed to increase the driving speed, or the driving speed in a case where skipping is performed is set equal to the driving speed in a case where no skipping is performed can be selected in accordance with, for example, the purpose of the recognition processing based on the read pixel signal.

### FIRST EMBODIMENT

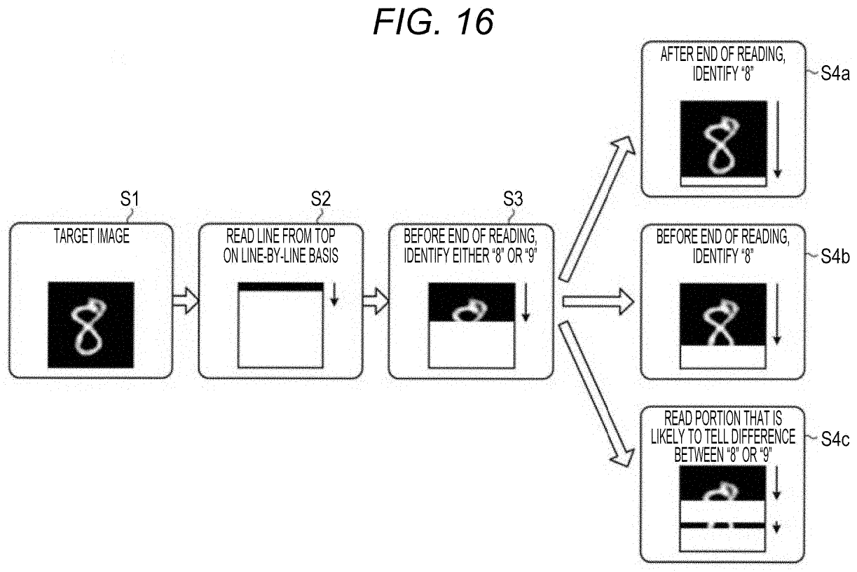

FIG. 16 is a schematic diagram for schematically describing recognition processing according to the present embodiment of the present disclosure. In FIG. 16, in step S1, the information processing system 1 (see FIG. 1) according to the present embodiment starts to capture a recognition target image.

Note that the target image is, for example, an image showing a handwritten digit “8”. Furthermore, it is assumed that a learning model learned using predetermined training data to be able to identify a digit is prestored in the memory 13 as a program, and the recognition processing unit 12 can identify a digit included in an image by executing the program loaded from the memory 13. Moreover, it is assumed that the information processing system 1 performs imaging using the rolling shutter method. Note that, even in a case where the information processing system 1 performs imaging using the global shutter method, the following processing is applicable in a similar manner to a case where the rolling shutter method is used.

When the imaging is started, the information processing system 1 sequentially reads, on a line-by-line basis, a frame from the upper end to the lower end of the frame in step S2.

When the line reading reaches a certain position, the recognition processing unit 12 recognizes digits “8” and “9” from the image of the read lines (step S3). For example, since the digits “8” and “9” whose upper half portions have a common feature portion, when the feature portion is recognized after sequentially reading lines from the top, the recognized object can be identified as either the digit “8” or “9”.

Here, as illustrated in step S4a, the whole of the object recognized after the end of reading up to the lower end line or a line near the lower end of the frame appears, and the object identified as either the digit “8” or “9” in step S2 is determined to be the digit “8”.

On the other hand, steps S4b and S4c are processes related to the present disclosure.

As illustrated in step S4b, the line reading further proceeds from the line position read in step S3, and the recognized object can be identified as the digit “8” even before the line position reaches the lower end of the digit “8”. For example, the lower half of the digit “8” and the lower half of the digit “9” are different in feature from each other. When the line reading proceeds up to a portion where the difference in feature becomes clear, it is possible to identify the object recognized in step S3 as either of the digits “8” and “9”. In the example illustrated in FIG. 16, the object is determined in step S4b to be the digit “8”.

Furthermore, as illustrated in step S4c, it is also conceivable that when the line reading further proceeds from the line position in step S3, that is, from the state of step S3, the line reading may jump to a line position at which it is likely that the object recognized in step S3 is identified as either of the digits “8” and “9”. When the line reading is performed on the line after the jump, it is possible to determine whether the object recognized in step S3 is either “8” or “9”. Note that the line position after the jump can be determined on the basis of a learning model learned in advance on the basis of predetermined training data.

Here, in a case where the object is determined in step S4b or step S4c described above, the information processing system 1 can terminate the recognition processing. It is therefore possible to shorten the recognition processing and reduce power consumption in the information processing system 1.

Note that the training data is data containing a plurality of combinations of input signals and output signals for each read unit. As an example, in the task of identifying a digit described above, data (line data, subsampled data, or the like) for each read unit can be used as the input signal, and data indicating a “correct digit” can be used as the output signal. As another example, in a task of detecting an object, for example, data (line data, subsampled data, or the like) for each read unit can be used as the input signal, and an object class (human body/vehicle/non-object), object coordinates (x, y, h, w), or the like can be used as the output signal. Alternatively, the output signal may be generated only from the input signal using self-supervised learning.

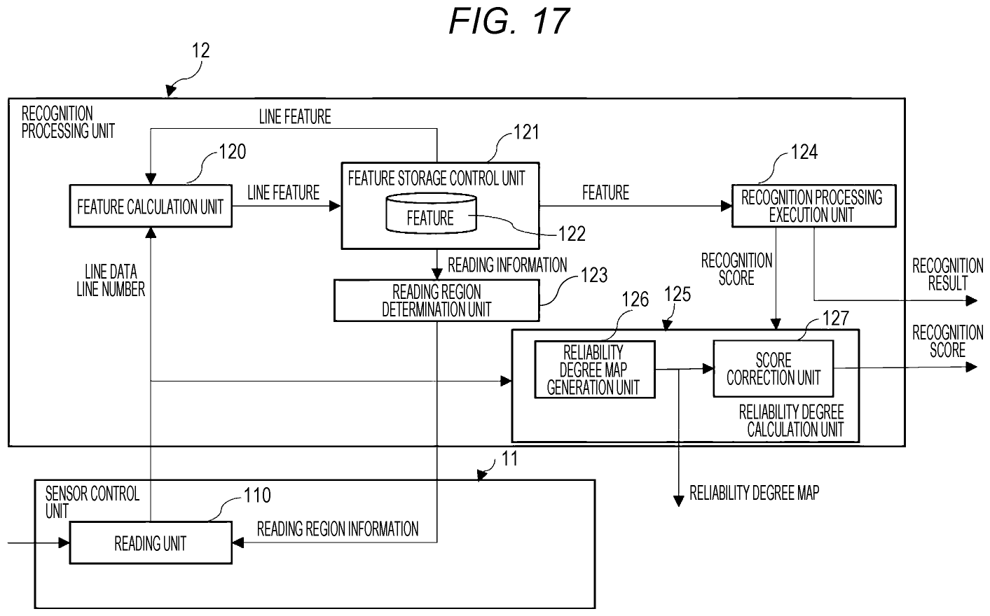

FIG. 17 is a functional block diagram of an example for describing the function of the sensor control unit 11 and the function of the recognition processing unit 12 according to the present embodiment.

In FIG. 17, the sensor control unit 11 includes a reading unit 110. The recognition processing unit 12 includes a feature calculation unit 120, a feature storage control unit 121, a reading region determination unit 123, a recognition processing execution unit 124, and a reliability degree calculation unit 125. Furthermore, the reliability degree calculation unit 125 includes a reliability degree map generation unit 126 and a score correction unit 127.

In the sensor control unit 11, the reading unit 110 sets reading pixels as a part of the pixel array unit 101 (see FIG. 4) in which the plurality of pixels is arranged in a two-dimensional array, and controls reading of a pixel signal from a pixel included in the pixel region. More specifically, the reading unit 110 receives reading region information indicating a reading region to be read by the recognition processing unit 12 from the reading region determination unit 123 of the recognition processing unit 12. The reading region information is, for example, a line number of one or a plurality of lines. Alternatively, the reading region information may be information indicating a pixel position in one line. Furthermore, combining one or more line numbers and information indicating the pixel position of one or more pixels in a line as the reading region information makes it possible to designate reading regions of various patterns. Note that the reading region is equivalent to the read unit. Alternatively, and the reading region and the read unit may be different from each other.

Furthermore, the reading unit 110 can receive information indicating exposure or analog gain from the recognition processing unit 12 or the visual field processing unit 14 (see FIG. 1). The reading unit 110 outputs the input information indicating the exposure or the analog gain, the reading region information, and the like to the reliability degree calculation unit 125.

The reading unit 110 reads the pixel data from the sensor unit 10 in accordance with the reading region information input from the recognition processing unit 12. For example, the reading unit 110 obtains a line number indicating a line to be read and pixel position information indicating a position of a pixel to be read in the line on the basis of the reading region information, and outputs the obtained line number and pixel position information to the sensor unit 10. The reading unit 110 outputs each pixel data acquired from the sensor unit 10 to the reliability degree calculation unit 125 together with the reading region information.

Furthermore, the reading unit 110 sets the exposure and the analog gain (AG) for the sensor unit 10 in accordance with the supplied information indicating the exposure and the analog gain. Moreover, the reading unit 110 can generate a vertical synchronization signal and a horizontal synchronization signal and supply the signals to the sensor unit 10.

In the recognition processing unit 12, the reading region determination unit 123 receives reading information indicating a reading region to be read next from the feature storage control unit 121. The reading region determination unit 123 generates reading region information on the basis of the received reading information, and outputs the reading region information to the reading unit 110.

Here, the reading region determination unit 123 can use, as the reading region indicated by the reading region information, for example, information in which reading position information for reading pixel data of a predetermined read unit is added to the predetermined read unit. The read unit is a set of one or more pixels, and is a unit of processing by the recognition processing unit 12 and the visual recognition processing unit 14. As an example, when the read unit is a line, a line number [L #x] indicating a line position is added as the reading position information. Furthermore, in a case where the read unit is a rectangular area including a plurality of pixels, information indicating the position of the rectangular region in the pixel array unit 101, for example, information indicating the position of a pixel in the upper left corner is added as the reading position information. In the reading region determination unit 123, the read unit to be applied is specified in advance. Furthermore, in a case where a subpixel is read under the global shutter method, the reading region determination unit 123 can include position information of the subpixel in the reading region. Alternatively, the reading region determination unit 123 may determine the read unit in accordance with, for example, an instruction from the outside of the reading region determination unit 123. Therefore, the reading region determination unit 123 functions as a read unit control unit that controls the read unit.

Note that the reading region determination unit 123 can also determine a reading region to be read next on the basis of recognition information supplied from the recognition processing execution unit 124 to be described later, and generate reading region information indicating the determined reading region.

In the recognition processing unit 12, the feature calculation unit 120 calculates, on the basis of the pixel data and the reading region information supplied from the reading unit 110, the feature of the region indicated by the reading region information. The feature calculation unit 120 outputs the calculated feature to the feature storage control unit 121.

The feature calculation unit 120 may calculate the feature on the basis of the pixel data supplied from the reading unit 110 and a past feature supplied from the feature storage control unit 121. Alternatively, the feature calculation unit 120 may acquire information for setting the exposure and the analog gain from the reading unit 110, for example, and further use the acquired information to calculate the feature.

In the recognition processing unit 12, the feature storage control unit 121 stores the feature supplied from the feature calculation unit 120 in a feature storage unit 122. Furthermore, when the feature is supplied from the feature calculation unit 120, the feature storage control unit 121 generates reading information indicating a reading region to be read next and outputs the reading information to the reading region determination unit 123.

Here, the feature storage control unit 121 can combine the already stored feature and the newly supplied feature and store the combined feature. Furthermore, the feature storage control unit 121 can delete an unnecessary feature among the features stored in the feature storage unit 122. The unnecessary feature may be, for example, a feature related to the previous frame, a feature calculated on the basis of a frame image of a scene different from a frame image for which a new feature has been calculated and already stored, or the like. Furthermore, the feature storage control unit 121 can also delete and initialize all the features stored in the feature storage unit 122 as necessary.

Furthermore, the feature storage control unit 121 generates a feature used for recognition processing by the recognition processing execution unit 124 on the basis of the feature supplied from the feature calculation unit 120 and the feature stored in the feature storage unit 122. The feature storage control unit 121 outputs the generated feature to the recognition processing execution unit 124.

The recognition processing execution unit 124 performs recognition processing on the basis of the feature supplied from the feature storage control unit 121. The recognition processing execution unit 124 performs object detection, face detection, or the like during recognition processing. The recognition processing execution unit 124 outputs a recognition result of the recognition processing to the output control unit 15 and the reliability degree calculation unit 125. The recognition result includes information indicating a detection score. Note that the detection score according to the present embodiment corresponds to a reliability degree.

The recognition processing execution unit 124 can also output recognition information including the recognition result generated by the recognition processing to the reading region determination unit 123. Note that the recognition processing execution unit 124 can receive the feature from the feature storage control unit 121 and perform recognition processing on the basis of, for example, a trigger generated by a trigger generation unit (not illustrated).

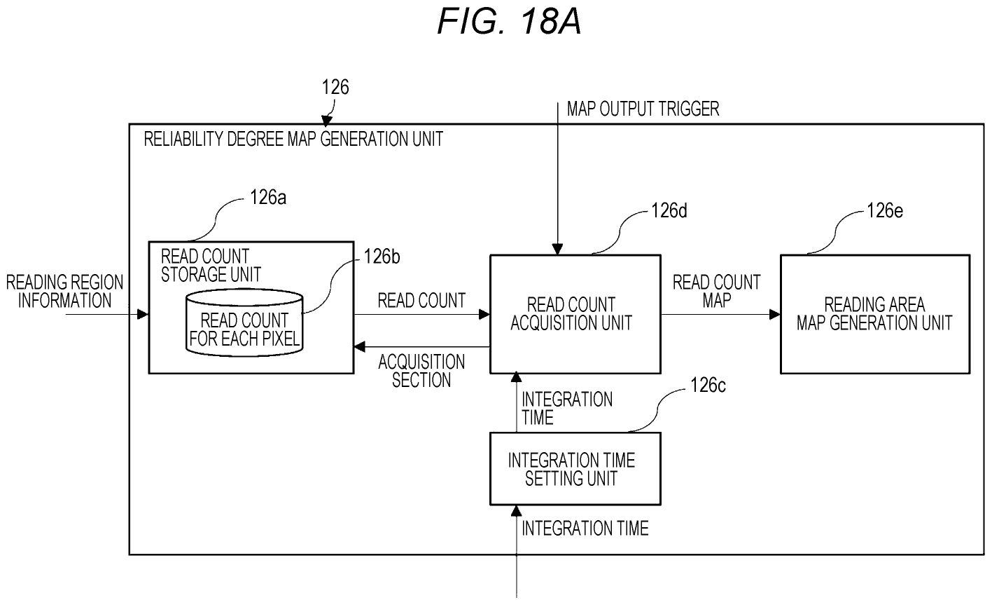

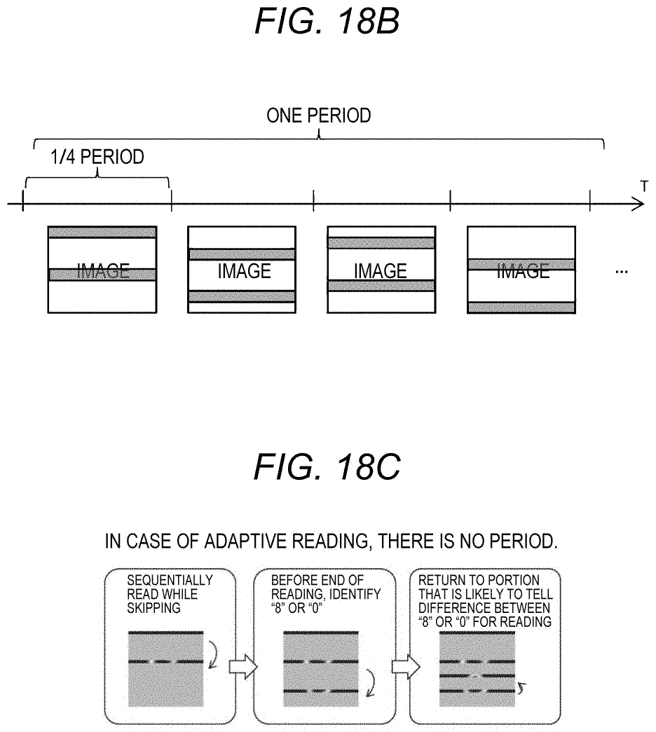

FIG. 18A is a block diagram illustrating a configuration of the reliability degree map generation unit 126. The reliability degree map generation unit 126 generates a reliability degree correction value for each pixel. The reliability degree map generation unit 126 includes a read count storage unit 126a, a read count acquisition unit 126b, an integration time setting unit 126c, and a reading area map generation unit 126e. Note that, in the present embodiment, a two-dimensional map of the reliability degree correction value for each pixel is referred to as a reliability degree map. Furthermore, for example, the measure of central tendency of the correction values in the recognition rectangle and a product of reliability degrees in the recognition rectangle are set as final reliability degree.

The read count storage unit 126a stores a read count of each pixel in the storage unit 126b together with a read time. The read count storage unit 126a can add the read count of each pixel already stored in the storage unit 126b to a newly supplied read count for each pixel to obtain a read count of each pixel.

FIG. 18B is a diagram schematically illustrating that a line data read count varies in a manner that depends on an integration section (time). The horizontal axis indicates time, and an example of line reading in a section (time) of ¼ period is schematically illustrated. Line data in a section (time) of one period is a range of the entire image data. On the other hand, with periodic read taken into consideration, the number of pieces of line data in ¼ period is ¼ of one period. As described above, when the integration time is ¼ of one period, the number of pieces of line data is, for example, two lines in FIG. 18B. On the other hand, when the integration time is 2/4 of one period, the number of pieces of line data is, for example, four lines in FIG. 18B, when the integration time is ¾ of one period, the number of pieces of line data is, for example, six lines in FIG. 18B, and when the integration time is one period, the number of pieces of line data is, for example, eight lines in FIG. 18B, that is, all pixels. Therefore, the integration time setting unit 126c supplies a signal including information regarding the integration section (time) to the read count acquisition unit 126d.

FIG. 18C is a diagram illustrating an example in which the reading position of the line data is adaptively changed in accordance with the recognition result from the recognition processing execution unit 124 illustrated in FIG. 16. In such a case, in the left diagram, the line data is sequentially read while skipping. Next, as illustrated in the middle diagram, when “8” or “0” is recognized in the middle, after returning to a part that is likely to tell a difference between “8” or “0”, and only the part is read. In such a case, there is no concept of a period. Even in such a case where there is no concept of a period, the line data read count varies in a manner that depends on the integration section (time). Therefore, the integration time setting unit 126c supplies a signal including information regarding the integration section (time) to the read count acquisition unit 126d.

The read count acquisition unit 126d acquires the read count of each pixel for each acquisition section from the read count storage unit 126a. The read count acquisition unit 126d supplies the integration time (integration section) supplied from the integration time setting unit 126c and the read count of each pixel for each acquisition section to the reading area map generation unit 126e. For example, the read count acquisition unit 126d can read the read count of each pixel from the read count storage unit 126a in accordance with a trigger generated by a trigger generation unit (not illustrated) together with the integration time and supply the read count to the reading area map generation unit 126e.

The reading area map generation unit 126e generates a reliability degree correction value for each pixel on the basis of the read count of each pixel for each acquisition section and the integration time. Details of the reading area map generation unit 126e will be described later.

Returning to FIG. 17 again, the score correction unit 127 calculates, for example, the measure of central tendency of the correction values in the recognition rectangle and a product of the reliability degrees in the recognition rectangle as the final reliability degree. Note that, in the present embodiment, a two-dimensional map of the reliability degree correction value for each pixel is referred to as a reliability degree map. The score correction unit 127 outputs the reliability degree after correction to the output control unit 15 (see FIG. 1).

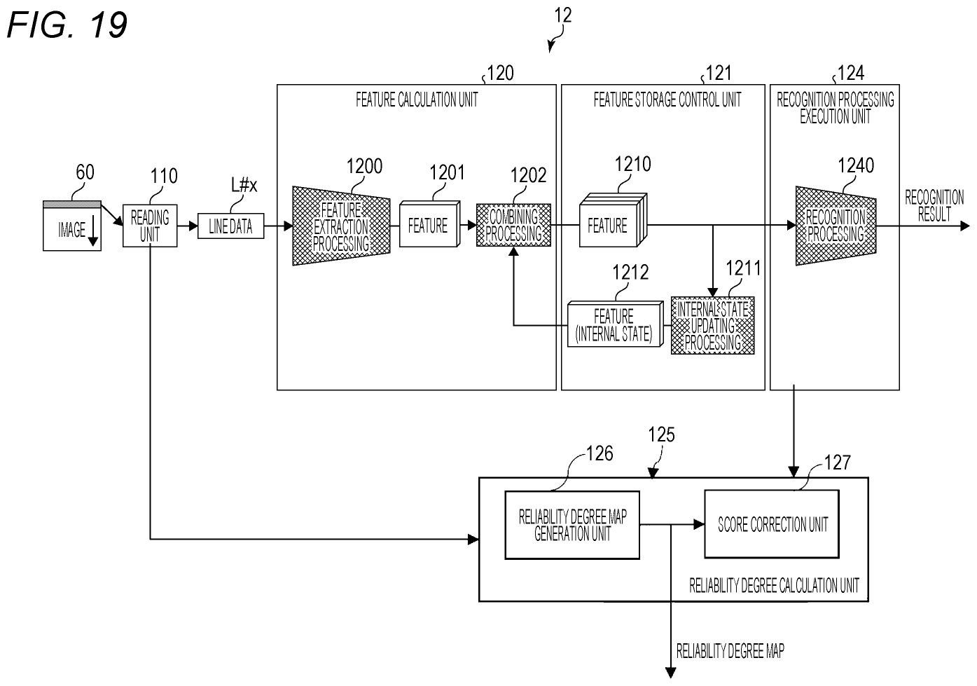

FIG. 19 is a schematic diagram illustrating an example of processing in the recognition processing unit 12 according to the present embodiment in more detail. Here, it is assumed that the reading region is a line, and the reading unit 110 reads pixel data on a line-by-line basis from the upper end to the lower end of the frame of an image 60.

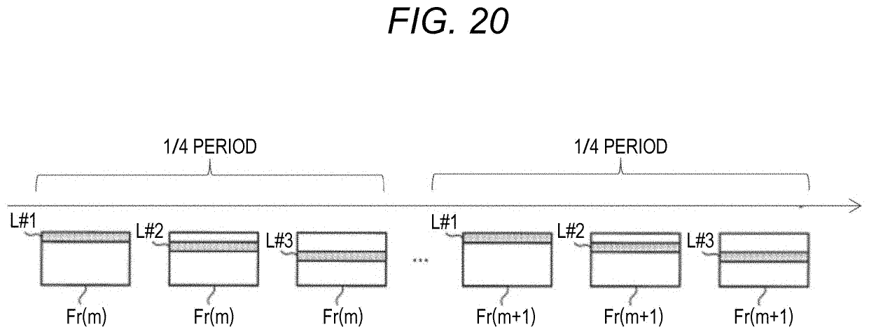

FIG. 20 is a schematic diagram for describing reading processing in the reading unit 110. For example, the read unit is a line, and pixel data reading is performed on a line-by-line basis on a frame Fr (x). In the example illustrated in FIG. 20, in a m-th frame Fr (m), the line reading sequentially performed from a line L #1 at the upper end of the frame Fr (m) in the order of lines L #2, L #3, . . . . When the line reading on the frame Fr (m) is completed, on the next (m+1)-th frame Fr (m+1), the line reading is sequentially performed from the line L #1 at the upper end in a similar manner.

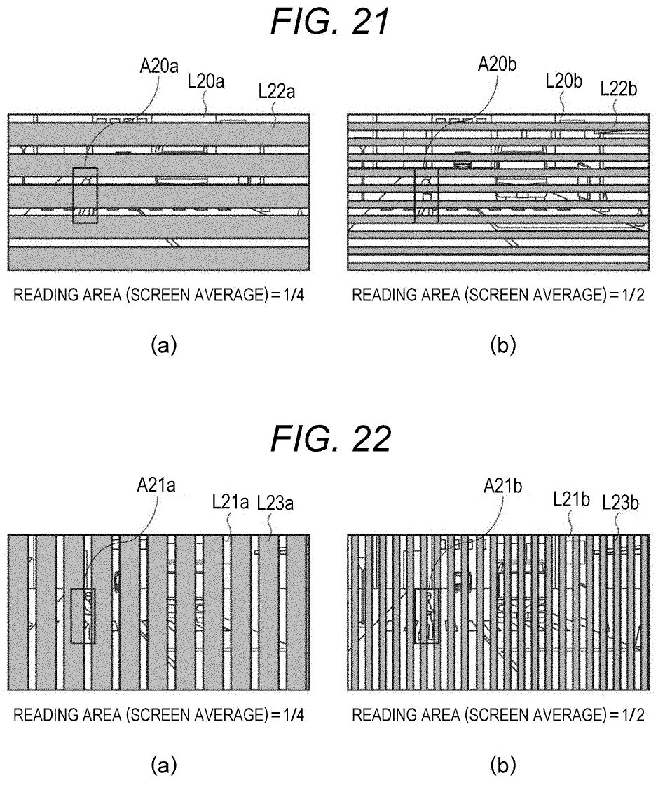

Furthermore, as illustrated in FIG. 21(a) to be described later, in the reading processing in the reading unit 110, line data may be read every three lines such that the first line from the top is regarded as the line L #1, the fourth line from the top is regarded as the line L #2, and the eighth line from the top is regarded as the line L #3. Similarly, line data may be read every three lines such that the first line from the top is regarded as the line L #1, the fourth line from the top is regarded as the line L #2, and the eighth line from the top is regarded as the line L #3.

Similarly, as illustrated in FIG. 21(b) to be described later, in the reading processing in the reading unit 110, line data may be read every other line such that the first line from the top is regarded as the line L #1, the third line from the top is regarded as the line L #2, and the fifth line from the top is regarded as the line L #3.

The line image data (line data) of the line L #x read on a line-by-line basis by the reading unit 110 is input to the feature calculation unit 120. Furthermore, information regarding the line L #x read on a line-by-line basis, that is, reading region information is supplied to the reliability degree map generation unit 126.

The feature calculation unit 120 performs feature extraction processing 1200 and combining processing 1202. The feature calculation unit 120 performs the feature extraction processing 1200 on the input line data to extract a feature 1201 from the line data. Here, the feature extraction processing 1200 extracts the feature 1201 from the line data on the basis of parameters obtained in advance by learning. The feature 1201 extracted by the feature extraction processing 1200 is combined by the combining processing 1202 with a feature 1212 processed by the feature storage control unit 121. A combined feature 1210 is passed to the feature storage control unit 121.

The feature storage control unit 121 performs internal state update processing 1211. The feature 1210 passed to the feature storage control unit 121 is passed to the recognition processing execution unit 124, and the internal state update processing 1211 is performed. The internal state update processing 1211 reduces the feature 1210 on the basis of the parameters learned in advance to update the internal state of the DNN, and generates the feature 1212 related to the updated internal state. The feature 1212 is combined with the feature 1201 by the combining processing 1202. The processing by the feature storage control unit 121 corresponds to processing using the RNN.

The recognition processing execution unit 124 performs recognition processing 1240 on the feature 1210 passed from the feature storage control unit 121, for example, on the basis of the parameters learned in advance using predetermined training data, and outputs the recognition result including information regarding the recognition region and the reliability degree.

As described above, in the recognition processing unit 12 according to the present embodiment, processing is performed on the basis of the parameters learned in advance in the feature extraction processing 1200, the combining processing 1202, the internal state update processing 1211, and the recognition processing 1240. The learning of the parameters is performed using, for example, training data based on an assumed recognition target.

The reliability degree map generation unit 126 of the reliability degree calculation unit 125 calculates the reliability degree correction value for each pixel on the basis of the reading region information and the integration time information using, for example, the information regarding the line L #x read on a line-by-line basis.

FIG. 21 is a diagram illustrating regions L20a, L20b (active regions) read on a line-by-line basis and regions L22a, L22b (inactive regions) that have not been read. In the present embodiment, a region from which image information has been read is referred to as an active region, and a region from which no image information has been read is referred to as an inactive region.

The reading area map generation unit 126e of the reliability degree map generation unit 126 generates the ratio of the active region to the entire image region as a screen average.

FIG. 21(a) illustrates a case where the area of the region L20a read on a line-by-line basis in ¼ period is ¼ of the entire image. On the other hand, FIG. 21(b) illustrates a case where the area of the region L20b read on a line-by-line basis in ¼ period is ½ of the entire image.

In such a case, the area map generation unit 126e generates the ratio of the active region to the entire image region, that is, ¼, as the screen average for FIG. 21(a). Similarly, the reading area map generation unit 126e generates the ratio of the active region to the entire image region, that is, ½, as the screen average for FIG. 21(b). As described above, the reading area map generation unit 126e can calculate the screen average using the information regarding the active region and the information regarding the inactive region.

The reading area map generation unit 126e can also calculate the screen average using filtering processing. For example, the value of the pixels in the region L20a is set to 1, the value of the pixels in the region L22a is set to 0, and smoothing operation processing is performed on the pixel values of the entire region of the image. For example, the smoothing operation processing is filtering processing for reducing high frequency components. In this case, for example, a vertical size of the filter is defined as a vertical length of the active region+a vertical length of the inactive area. In FIG. 21(a), for example, it is assumed that the vertical length of the inactive region corresponds to 12 pixels and the vertical length of the inactive region corresponds to three pixels. In this case, for example, the vertical size of the filter is a length corresponding to 16 pixels. With the above-described vertical size of this filter, regardless of the horizontal size, the result of the filtering processing is calculated as ¼ that is the screen average.

Similarly, in FIG. 21(b), for example, it is assumed that the vertical length of the active region corresponds to three pixels, and the vertical length of the inactive region corresponds to three pixels. In this case, for example, the vertical size of the filter is a length corresponding to six pixels. With the above-described vertical size of this filter, regardless of the horizontal size, the result of the filtering processing is calculated as ½ that is the screen average.

The score correction unit 127 corrects a reliability degree corresponding to a recognition region A20a on the basis of the measure of central tendency of the correction values in the recognition region A20a. For example, a statistical value such as a mean, a median, or a mode of the correction values in the recognition region A20a can be used as the measure of central tendency. For example, the measure of central tendency is set to ¼ that is the mean of the correction values in the recognition region A20a. As described above, the score correction unit 127 can use the read screen average for calculation of the reliability degree.

On the other hand, the score correction unit 127 corrects a reliability degree corresponding to a recognition region A20b on the basis of a measure of central tendency of the correction values in the recognition region A20b. For example, it is assumed that the measure of central tendency is ½ that is a mean of the correction values in the recognition region A20b. As a result, the reliability degree corresponding to the recognition region A20a is corrected on the basis of ¼, and the reliability degree corresponding to the recognition region A20a is corrected on the basis of ½. In the present embodiment, a value obtained by multiplying the measure of central tendency of the correction values in the recognition region A20b by the reliability degree corresponding to the recognition region A20b is set as the final reliability degree. Note that the reliability degree may be multiplied by an output value after a function operation is performed with the measure of central tendency as an input using a function having a non-linear input/output relation.

As described above, the read regions L20a, L20b and the unread regions L22a, L22b are generated by the sensor control. Therefore, it is different from general recognition processing of reading pixels in the entire region. As a result, when it is applied to a case where the general regions L20a, L20b from which the reliability degree has been read and the regions L22a, L22b from which no reliability degree has been read are generated, there is a possibility that the accuracy of the reliability degree will deteriorate. On the other hand, in the present embodiment, the correction value of each pixel in accordance with the read regions L20a, L20b/(the read regions L20a, L20b+unread regions L22a, L22b) read by the reliability degree map generation unit 126 is calculated as the screen average. Then, the score correction unit 127 corrects the reliability degree on the basis of the correction value, so that it is possible to calculate the reliability degree with higher accuracy.

Note that the functions of the feature calculation unit 120, the feature storage control unit 121, the reading region determination unit 123, the recognition processing execution unit 124, and the reliability degree calculation unit 125 described above are implemented by, for example, a program stored in the memory 13 or the like included in the information processing system 1, the program being loaded and executed.

In the above description, the line reading is performed from the upper end side to the lower end side of the frame, but the line reading is not limited to this example. For example, the line reading may be performed from the left end side to the right end side. Alternatively, the line reading may be performed from the right end side to the left end side.

FIG. 22 is a diagram illustrating regions L21a, L21b that have been read on a line-by-line basis from the left end side to the right end side and regions L23a, L23b that have not been read. FIG. 22(a) illustrates a case where the area of the region L21a read on a line-by-line basis is ¼ of the entire image. On the other hand, FIG. 22(b) illustrates a case where the area of the region L21b read on a line-by-line basis is ½ of the entire image.

In this case, the reading area map generation unit 126e of the reliability degree map generation unit 126 generates ¼, which is the ratio of the active region to the entire image region as the screen average for FIG. 22(a). Similarly, the area map generation unit 126e generates ½, which is the ratio of the active region to the entire image region, as the screen average for FIG. 21(b).

The score correction unit 127 corrects the reliability degree corresponding to the recognition region A21a on the basis of the measure of central tendency of the correction values in the recognition region A21a. For example, it is assumed that the measure of central tendency is ¼ that is a mean of the correction values in the recognition region A21a.

On the other hand, the score correction unit 127 corrects the reliability degree corresponding to the recognition region A21b on the basis of the measure of central tendency of the correction values in the recognition region A21b. For example, it is assumed that the measure of central tendency is ½ that is a mean of the correction values in the recognition region A21b.

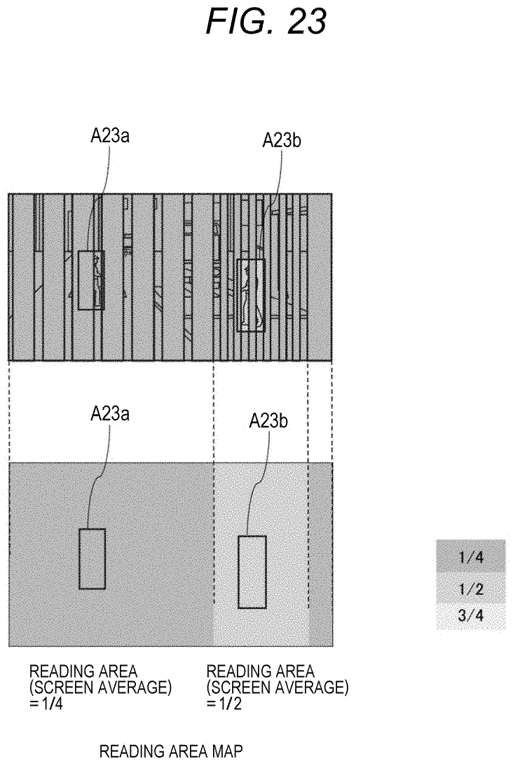

FIG. 23 is a diagram schematically illustrating an example of reading performed on a line-by-line basis from the left end side to the right end side. The upper-side diagram illustrates a read region and an unread region. In a region where a recognition region A23a exists, a ratio of an area in which line data exists is ¼, and in a region where a recognition region A23b exists, a ratio of an area in which line data exists is ½. That is, this is an example in which a region in which line data is read is adaptively changed by the recognition processing execution unit 124.

The lower-side diagram illustrates a reliability degree map generated by the reading area map generation unit 126e. Here, a two-dimensional distribution in the reading area map is illustrated. As described above, the reading area map is a diagram illustrating a two-dimensional distribution of the reliability degree correction value based on the read data area. The correction value is indicated by a gray-scale value. For example, the reading area map generation unit 126e assigns 1 to the active region and 0 to the image inactive region as described above. Then, for example, the reading area map generation unit 126e performs smoothing operation processing on the entire image, for example, for each rectangular range centered on the pixel, and generates an area map. For example, the rectangular range is a range of 5*5 pixels. With such processing, in FIG. 23, in a region where the area ratio is ¼, although there is a variation depending on the pixel position, the correction value of each pixel is approximately ¼. On the other hand, in a region where the area ratio is ½, although there is a variation depending on the pixel position, the correction value of each pixel is approximately ½. Note that the predetermined range is not limited to a rectangle, and may be, for example, an ellipse, a circle, or the like. Furthermore, in the present embodiment, an image obtained by assigning predetermined values to the active region and the inactive region and performing smoothing operation processing is referred to as an area map.

The score correction unit 127 corrects the reliability degree corresponding to the recognition region A21b for the recognition region A23a on the basis of the measure of central tendency of the correction values in the recognition region A21b. For example, it is assumed that the measure of central tendency is ¼, which is the mean of the correction values in the recognition region A23ab. On the other hand, for the recognition region A23b, the reliability degree corresponding to the recognition region A21b is corrected on the basis of the measure of central tendency of the correction values in the recognition region A23b. For example, it is assumed that the measure of central tendency is ½, which is the mean of the correction values in the recognition region A23b. As described above, displaying the reliability degree map makes it possible to entirely grasp the reliability degree of the recognition region in the image region in a short time.

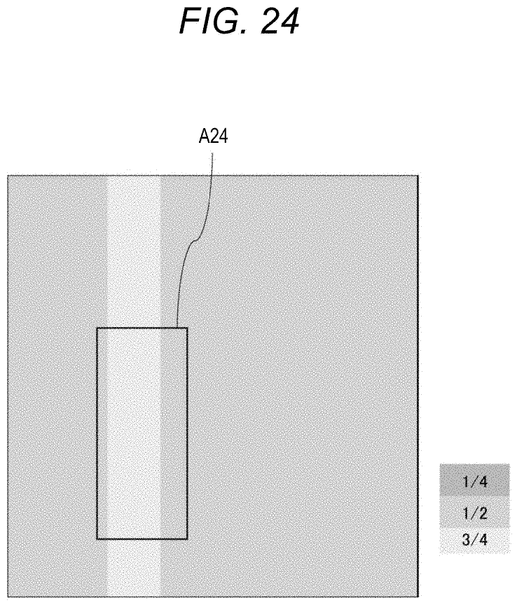

FIG. 24 is a diagram schematically illustrating a value of the reliability degree map in a case where the reading area changes in a recognition region A24. As illustrated in FIG. 24, when the reading area changes in the recognition region A24, the value of the reliability degree map also changes in the recognition region A24. In this case, the score correction unit 127 may use, as the measure of central tendency in the recognition region A24, a value of the mode in the recognition region A24, a value of the median in the recognition region A24, a weighted integrated value with a distance from the center of the recognition region A24 as a weight, or the like.

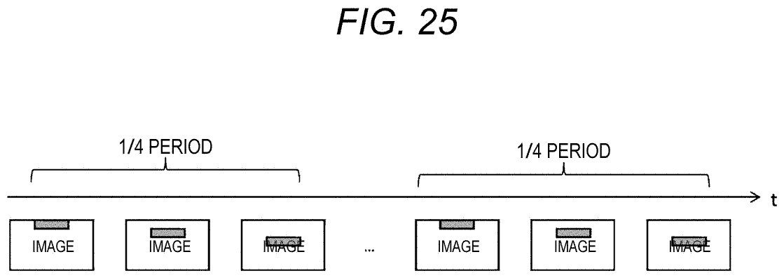

FIG. 25 is a diagram schematically illustrating an example in which the reading range of line data is restricted. As illustrated in FIG. 25, the reading range of line data may be changed at each reading timing. Also in this case, the reading area map generation unit 126e can generate the reliability degree map in a similar manner to the above.

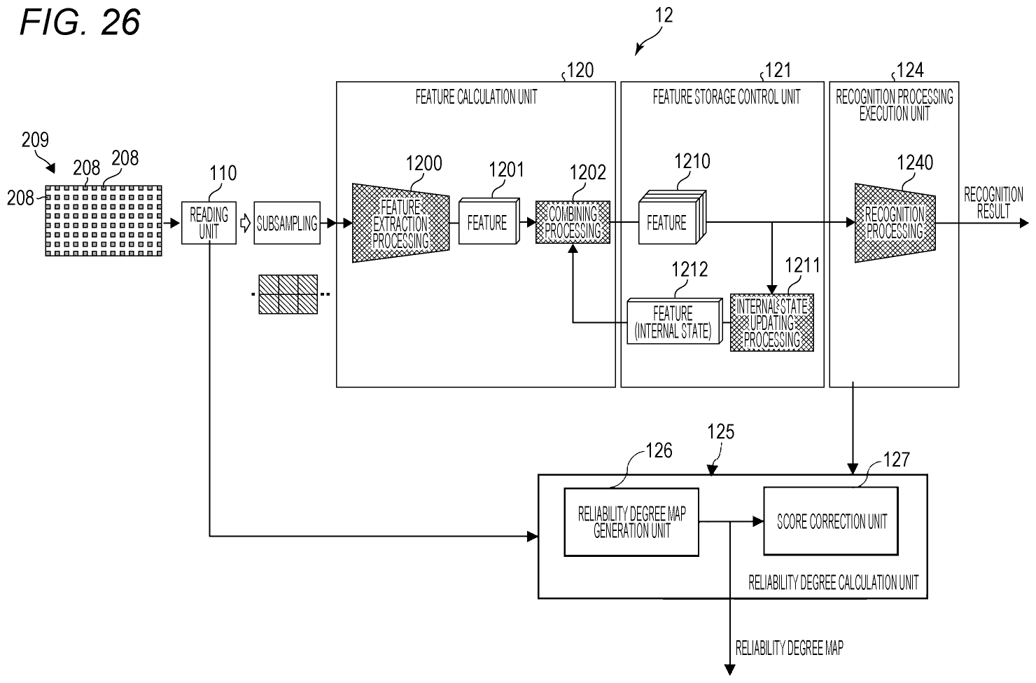

FIG. 26 is a diagram schematically illustrating an example of identification processing (recognition processing) using the DNN in a case where time-series information is not used. In this case, as illustrated in FIG. 26, one image is subsampled and input to the DNN. In the DNN, identification processing is performed on the input image, and an identification result is output.

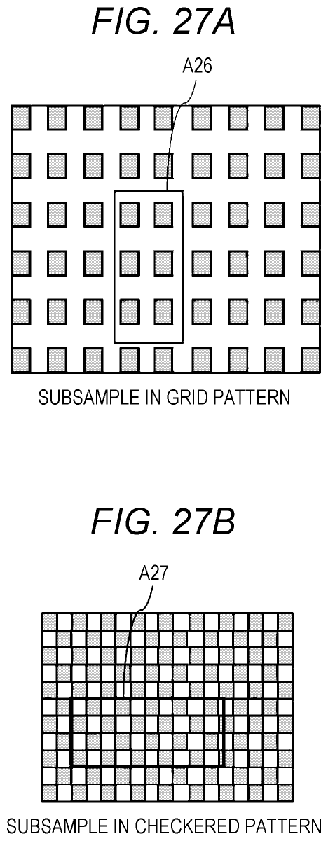

FIG. 27A is a diagram illustrating an example in which one image is subsampled in a grid pattern. Even in a case where the entire image is subsampled as described above, the reading area map generation unit 126e can generate the reliability degree map by using a ratio of the number of sampled pixels to the total number of pixels. In this case, for the recognition region A26, the score correction unit 127 corrects the reliability degree corresponding to the recognition region A26 on the basis of the measure of central tendency of the correction values in the recognition region A26.

FIG. 27B is a diagram illustrating an example in which one image is subsampled in a checkered pattern. Even in a case where the entire image is subsampled as described above, the reading area map generation unit 126e can generate the reliability degree map by using a ratio of the number of sampled pixels to the total number of pixels. In this case, for the recognition region A27, the score correction unit 127 corrects the reliability degree corresponding to the recognition region A27 on the basis of the measure of central tendency of the correction values in the recognition region A27.

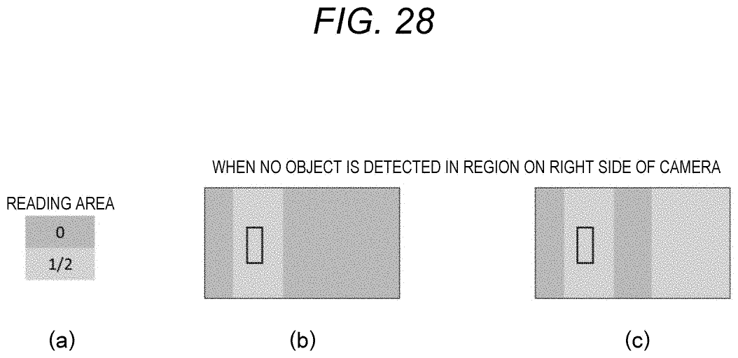

FIG. 28 is a diagram schematically illustrating a case where the reliability degree map is used for a traffic system, such as a moving object. (a) is a gray-scale diagram illustrating a mean of a reading area. The density indicated by “0” indicates that the mean of the read recognition is 0, and the density indicated by “½” indicates that the mean of the read recognition is ½.

(b) and (c) illustrate an example in which the reading area map is used as the reliability degree map. The correction value in the right region of (b) is lower than the correction value in the right region of (c). As a result, for example, under the situation as illustrated in (b), in a case where the reliability degree map is not used, the course is changed to the right side of the camera although there is a possibility that an object is present on the right side of the camera. On the other hand, when the reliability degree map is used, the region on the right side of the camera is low in correction value and low in reliability degree, so that, in consideration of the possibility that an object is present on the right side of the camera, it is possible to stop without changing the course to the right side of the camera.

On the other hand, as illustrated in (c), when the correction value in the region on the right side of the camera increases, the reliability degree increases, so that it is determined that there is no object on the right side of the camera, and the course can be changed to the right side of the camera.

For example, in a case where the reliability degree is low even if the detection score is high (in a case where the correction value based on the read area is low), it is also necessary to consider a possibility that there is no object. As an update example of the reliability degree, as described above, it is possible to calculate reliability degree=detection score (original reliability degree)*correction value based on the read area. In a case where the degree of urgency is low (for example, in a case where there is no possibility of immediate collision), if the reliability degree (value after correction with the correction value based on the read area) is low even if the detection score is high, it can be determined that there is no object there. In a case where the degree of urgency is high (for example, in a case where there is a possibility of immediate collision), if the detection score is high even if the reliability degree (value after correction with the correction value based on the read area) is low, it can be determined that there is an object there. As described above, the use of the reliability degree map makes it possible to more safely control a moving object such as a car.

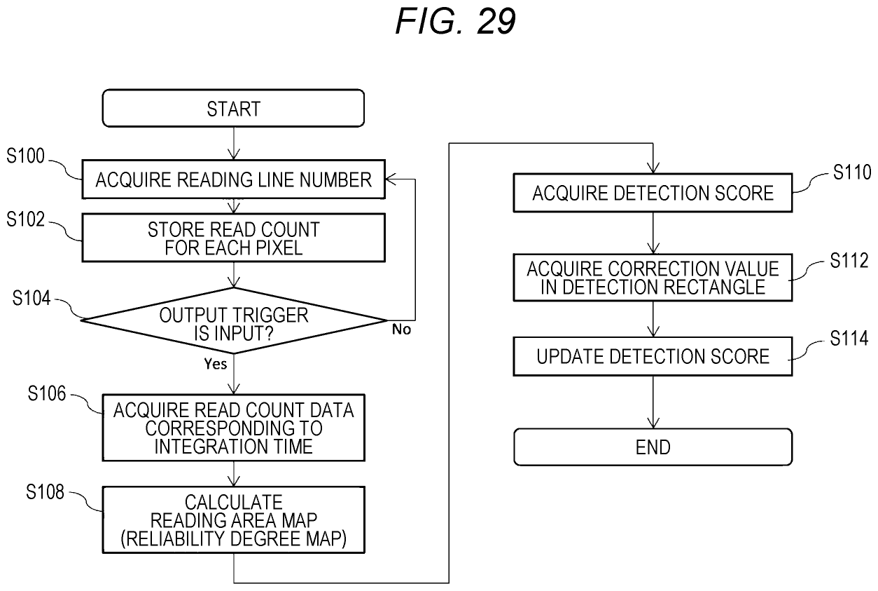

FIG. 29 is a flowchart illustrating a flow of processing in the reliability degree calculation unit 125. Here, a processing example in a case of line data will be described.

First, the read count storage unit 126a acquires reading region information including reading line number information from the reading unit 110 (step S100), and stores the read pixel and time information in the storage unit 126b as read count information for each pixel (step S102).

Next, the read count acquisition unit 126d determines whether or not a trigger signal for map generation has been input (step S104). In a case where there is no input (No in step S104), the processing from step S100 is repeated. On the other hand, there is input (Yes in step S104), the read count acquisition unit 126d acquires the integration time, for example, the read count of each pixel within a time corresponding to ¼ period from the read count storage unit 126a (step S106). Here, it is assumed that the read count of each pixel within the time corresponding to ¼ period is one. For example, each pixel may be read several times within the time corresponding to ¼ period, but this case will be described later.

Next, the reading area map generation unit 126e generates a correction value indicating a ratio of the reading area for each pixel (step S108). Subsequently, the reading area map generation unit 126e outputs two-dimensional correction value assignment data to the output control unit 15 as the reliability degree map.

Next, the score correction unit 127 acquires a detection score for a rectangular region (for example, the recognition region A20a in 21), that is, a reliability degree from the recognition processing execution unit 124 (step S110).

Next, the score correction unit 127 acquires a measure of central tendency of the correction values in the rectangular region (for example, the recognition region A20a in 21) (step S112). For example, a statistical value such as a mean, a median, or a mode of the correction values in the recognition region A20a can be used as the measure of central tendency.

Then, the score correction unit 127 updates the detection score on the basis of the detection score and the measure of central tendency (step S114), outputs the detection score as the final reliability degree, and brings the entire processing into an end.

As described above, according to the present embodiment, the reliability degree correction value for each pixel according to the regions L20a, L20b/(read regions L20a, L20b+unread regions L22a, L22b) (FIG. 21) read by the reliability degree map generation unit 126 is calculated. Then, the score correction unit 127 corrects the reliability degree on the basis of the correction value, so that it is possible to calculate the reliability degree with higher accuracy. As a result, even in a case where the read regions L20a, L20b and the unread regions L22a, L22b are generated by the sensor control, values of the reliability degrees after correction can be uniformly processed, so that the recognition accuracy of the recognition processing can be further increased.

### FIRST MODIFICATION OF FIRST EMBODIMENT

An information processing system 1 according to a first modification of the first embodiment is different from the information processing system 1 according to the first embodiment in that a range in which the reliability degree correction value is calculated can be calculated on the basis of the receptive field of the feature. Hereinafter, differences from the information processing system 1 according to the first embodiment will be described.

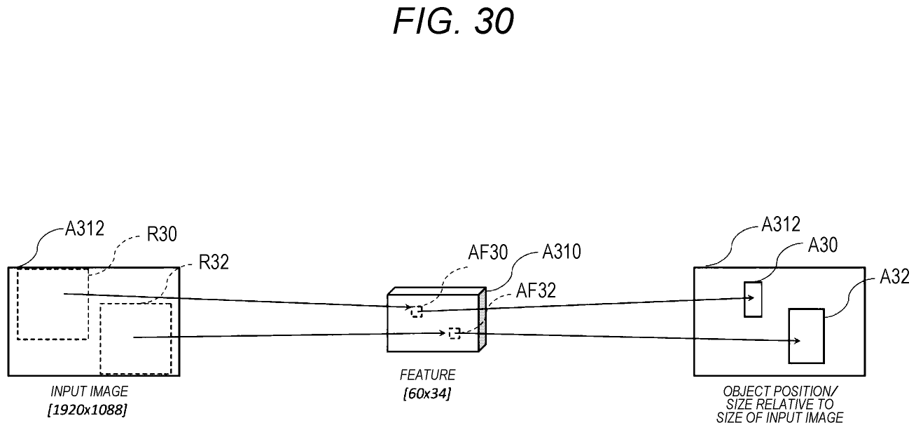

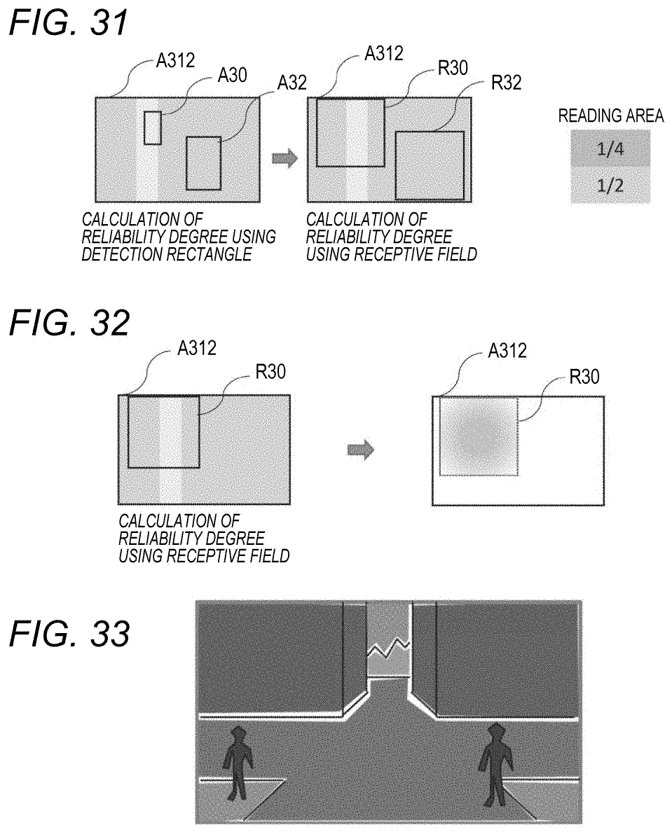

FIG. 30 is a schematic diagram illustrating a relation between the feature and the receptive field. The receptive field refers to a range of an input image that is referred to when one feature is calculated, in other words, a range of an input image covered by one feature. A receptive field R30 in an image A312 corresponding to a feature region AF30 in a recognition region A30 in the image A312, and a receptive field R32 in the image A312 corresponding to a feature region AF32 in a recognition region A32 are illustrated. As illustrated in FIG. 31, a feature of the feature region AF30 is used as a feature corresponding to the recognition region A30. In the present embodiment, a range in the image A312 used or calculating the feature corresponding to the recognition region A30 is referred to as the receptive field R30. Similarly, a range in the image A312 used for calculating the feature corresponding to the recognition region A32 corresponds to the receptive field R32.

FIG. 31 is a diagram schematically illustrating the recognition regions A30, A32 and the receptive fields R30, R32 in a reliability degree map. A score correction unit 127 according to the first modification is different from the score correction unit 127 according to the first embodiment in that the score correction unit 127 according to the first modification can also calculate the measure of central tendency of the correction values using information regarding the receptive fields R30, R32, and for example, the receptive field R30 and the recognition region A30 in the image 312 are different in position and size from each other, so that the mean of the reading area may be different. In order to more accurately reflect an influence of the reading region, it is desirable to use the range of the receptive field R30 used for calculating the feature.

Therefore, for example, the score correction unit 127 corrects a detection score of the recognition region A30 using the measure of central tendency of the correction values in the receptive field R30. For example, the score correction unit 127 can set a statistical value such as a mode of the correction values in the receptive field R30 as the measure of central tendency. Then, the score correction unit 127 updates the detection score of the recognition region A30 by, for example, multiplying the detection score by the measure of central tendency in the receptive field R30. The updated detection score is set as the final reliability degree. Similarly, the score correction unit 127 can use a statistical value such as a mean, a median, or a mode of the correction values in the receptive field R32 as the measure of central tendency. Then, the score correction unit 127 updates the detection score of the recognition region A30 by, for example, multiplying the detection score by the measure of central tendency in the receptive field R32.

As illustrated in FIG. 31, when the detection score is updated using the recognition regions A30, A32, the reliability degree of the recognition region A30 is updated to be higher than the reliability degree of the recognition region A32. On the other hand, in a case where the detection score is updated using the receptive fields R30, R32, for example, if the measure of central tendency is the mode of the receptive fields R30, R32, a ratio between the updated reliability degree of the recognition region A30 and the updated reliability degree of the recognition region A32 is equivalent. As described above, the reliability degree may be updated with higher accuracy by considering the ranges of the receptive fields R30, R3.

FIG. 32 is a diagram schematically illustrating a contribution degree to the feature in the recognition region A30. Shades in the receptive field R30 in the right diagram indicate a weighting value reflecting a contribution degree to the recognition processing on the feature in the recognition region A30 (see FIG. 31). The higher the strength, the higher the contribution degree.

The score correction unit 127 may add up the correction values in the receptive field R30 using such a weighting value and use the resultant value as the measure of central tendency. Since the contribution degree to the feature is reflected, the accuracy of the updated reliability degree of the recognition region A30 is further increased.

### SECOND MODIFICATION OF FIRST EMBODIMENT

An information processing system 1 according to a second modification of the first embodiment is applied to a case where semantic segmentation is performed as a recognition task. The semantic segmentation is a recognition method that associates (assign, set, classify) all pixels in an image with labels or categories in accordance with characteristics of each pixel or nearby pixels, and is performed by deep learning using a neural network, for example. By means of semantic segmentation, a set of pixels forming the same label or category can be recognized on the basis of the label or category associated with each pixel, and the image can be divided into a plurality of regions at a pixel level, so that a target object having an irregular shape can be clearly distinguished from objects around the target object and detected. For example, when the semantic segmentation task is performed on a general roadway scene, a vehicle, a pedestrian, a sign, a roadway, a sidewalk, a signal, sky, a roadside tree, a guardrail, and other objects can be classified into their respective categories and recognized in an image. The label of this classification, the type of the category, and the number thereof can be changed by using a data set used for learning and individual settings. For example, there may be various changes depending on purposes or device performance, such as a case where only two labels or categories of a person and a background are used, or a case where a plurality of detailed labels or categories are used as described above. Hereinafter, differences from the information processing system 1 according to the first embodiment will be described.

FIG. 33 is a schematic diagram illustrating an image on which recognition processing is performed on the basis of general semantic segmentation. In this processing, the semantic segmentation processing is performed on the entire image, so that labels or categories that are associated with pixels on a pixel-by-pixel basis are set, and an image is divided into a plurality of regions at a pixel level, each of the regions being a set of pixels forming the same label or category. Then, in the semantic segmentation, generally, the reliability degree of the set label or category is output for each pixel. Furthermore, a mean of reliability degrees of each set of pixels forming the same label or category may be calculated, and one reliability degree may be calculated for each set of pixels using the mean as the reliability degree of the set of pixels. Furthermore, in addition to the mean, a median or the like may be used.

In the second modification of the first embodiment, the score correction unit 127 corrects the reliability degree calculated by the general semantic segmentation processing. That is, correction using the reading region (screen average) in the image, correction based on the measure of central tendency of the correction values of the recognition region, correction using the reliability degree map (map combining unit 126j, reading area map generation unit 126e, reading frequency map generation unit 126f, multiple exposure map generation unit 126g, and dynamic range map generation unit 126h), and correction using the receptive field are performed. As described above, in the second modification of the first embodiment, the reliability degree calculation can be performed with higher accuracy by calculating the corrected reliability degree by applying the present invention to the recognition processing by the semantic segmentation.

### SECOND EMBODIMENT

An information processing system 1 according to a second embodiment is different from the information processing system 1 according to the first embodiment in that the correction value of the reliability degree can be calculated on the basis of pixel reading frequency. Hereinafter, differences from the information processing system 1 according to the first embodiment will be described.

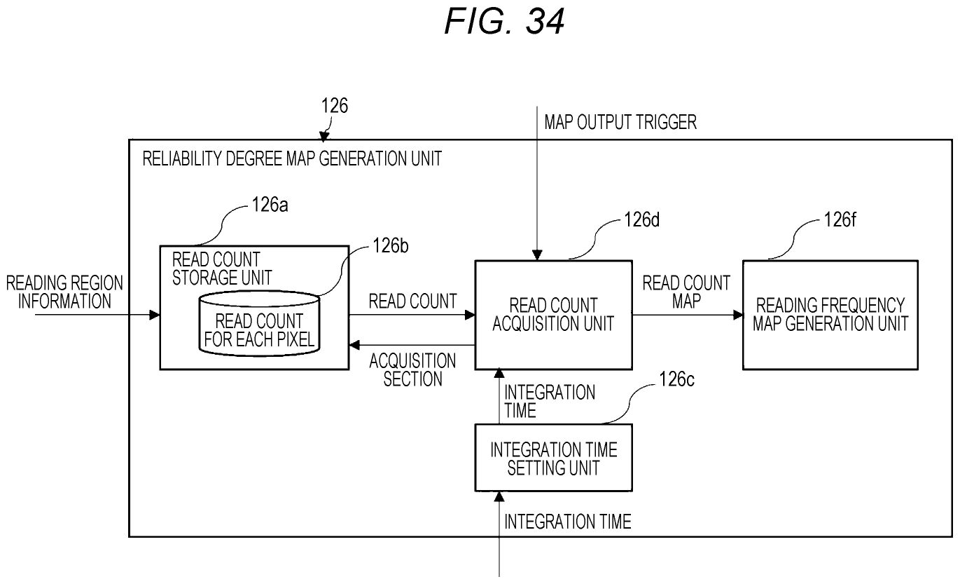

FIG. 34 is a block diagram of a reliability degree map generation unit 126 according to the second embodiment. As illustrated in FIG. 34, the reliability degree map generation unit 126 further includes a reading frequency map generation unit 126f.

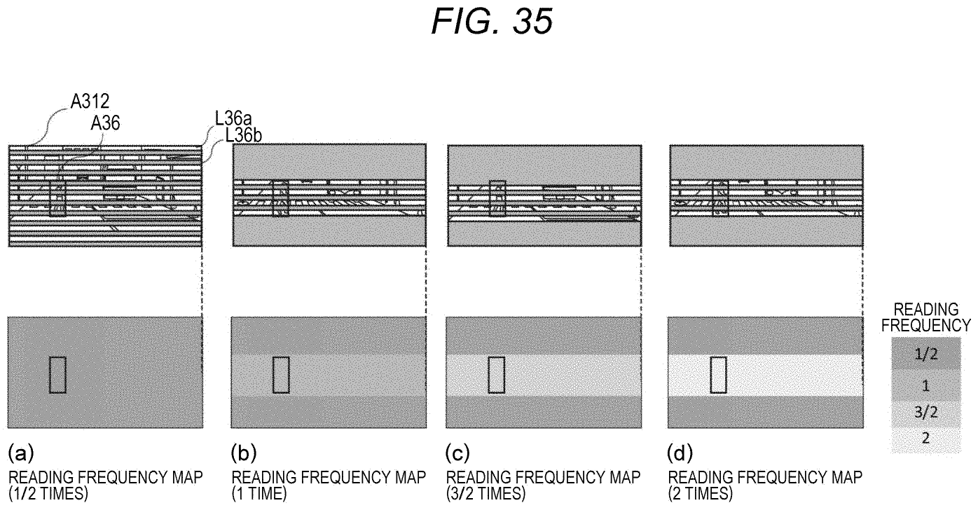

FIG. 35 is a diagram schematically illustrating a relation between a recognition region A36 and line data L36a. The upper diagram illustrates the line data L36a and an unread region L36b, and the lower diagram illustrates a reliability degree map. Here, it is a reading frequency map. (a) illustrates a case where the read count of the line data L36a is 1, (b) illustrates a case where the read count is 2, (c) illustrates a case where the read count is 3, and (d) illustrates a case where the read count is 4.

The reading frequency map generation unit 126f performs smoothing operation processing on appearance frequency of pixels in the entire region of the image. For example, the smoothing operation processing is filtering processing for reducing high frequency components.

As illustrated in FIG. 35, in the present embodiment, for example, the smoothing operation processing is performed on the entire image, for example, on each rectangular range centered on the pixel. For example, the rectangular range is a range of 5*5 pixels. With such processing, in FIG. 35(a), although there is a variation depending on the pixel position, the correction value of each pixel is approximately ½. On the other hand, in FIG. 35(b), a region where the line data L36a is read corresponds to 1, in FIG. 35(c), the region where the line data L36a is read corresponds to 3/2, and in FIG. 35(d), the region where the line data L36a is read corresponds to 2. Furthermore, in a region where no data is read, the reading frequency is 0.

The score correction unit 127 corrects the reliability degree corresponding to the recognition region A36 on the basis of the measure of central tendency of the correction values in the recognition region A36. For example, a statistical value such as a mean, a median, and a mode of the correction values in the recognition region A36 can be used as the measure of central tendency.

As described above, according to the present embodiment, the reliability degree map generation unit 126 performs the smoothing operation processing on the appearance frequency of the pixel within the predetermined range centered on the pixel for the entire image region, and calculates the correction value of the reliability degree for each pixel in the entire image region. Then, since the score correction unit 127 corrects the reliability degree on the basis of the correction value, it is possible to calculate, with higher accuracy, the reliability degree reflecting the pixel reading frequency. As a result, even in a case where there is a difference in pixel reading frequency, the value of the reliability degree after the correction can be uniformly processed, so that the recognition accuracy of the recognition processing can be further increased.

### THIRD EMBODIMENT

An information processing system 1 according to a third embodiment is different from the information processing system 1 according to the first embodiment in that the correction value of the reliability degree can be calculated on the basis of pixel exposure count. Hereinafter, differences from the information processing system 1 according to the first embodiment will be described.

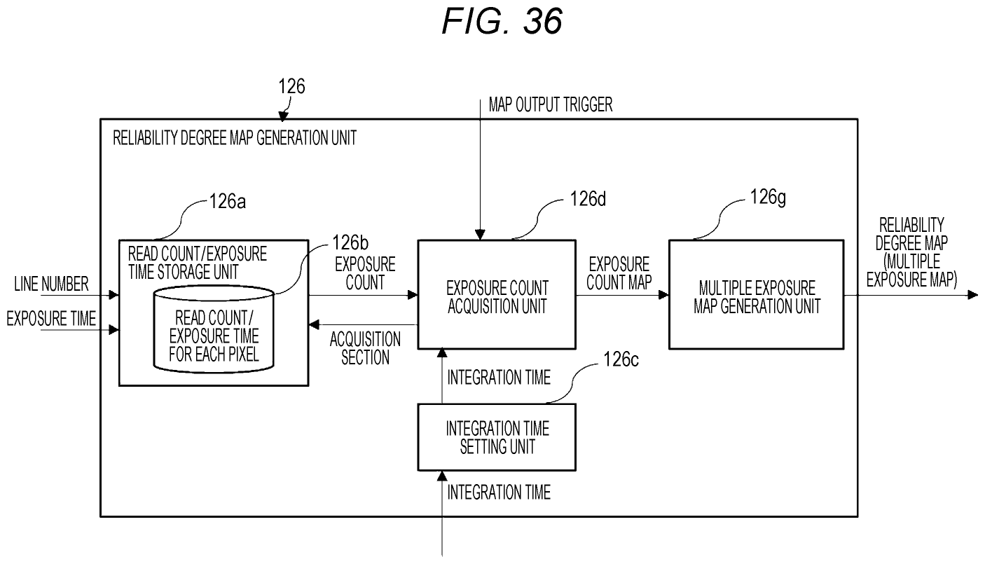

FIG. 36 is a block diagram of a reliability degree map generation unit 126 according to the third embodiment. As illustrated in FIG. 36, the reliability degree map generation unit 126 further includes a multiple exposure map generation unit 126g.

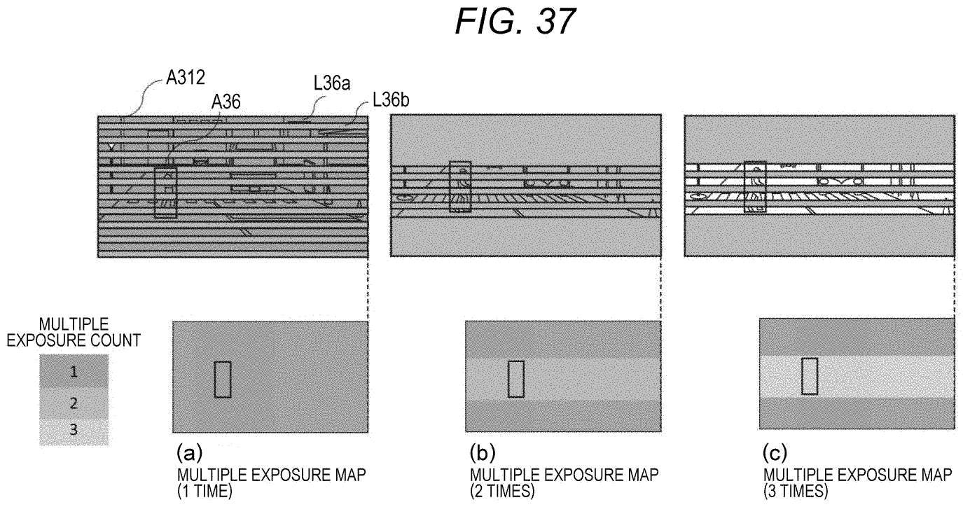

FIG. 37 is a diagram schematically illustrating a relation with exposure frequency of line data L36a. The upper diagram illustrates the line data L36a and an unread region L36b, and the lower diagram illustrates a reliability degree map. Here, it is a multiple exposure map. (a) illustrates a case where the exposure count of the line data L36a is 2, (b) illustrates a case where the exposure count is 4, and (c) illustrates a case where the exposure count is 6.

The reading frequency map generation unit 126f performs smoothing operation processing on the exposure count of pixels within a predetermined range centered on the pixel for the entire image region, and calculates the correction value of the reliability degree for each pixel in the entire image region. For example, the smoothing operation processing is filtering processing for reducing high frequency components.

As illustrated in FIG. 37, in the present embodiment, for example, it is assumed that the predetermined range on which the smoothing operation processing is performed is a rectangular range corresponding to a 5*5 pixel range. With such processing, in FIG. 37(a), although there is a variation depending on the pixel position, the correction value of each pixel is approximately ½. On the other hand, in FIG. 37(b), the exposure count of the region where the line data L36a is read is 1, in FIG. 37(c), the exposure count of the region where the line data L36a is read is 3/2, and in FIG. 37(d), the exposure count of the region where the line data L36a is read is 2. Furthermore, in a region where no data is read, the reading frequency is 0.

The score correction unit 127 corrects the reliability degree corresponding to the recognition region A36 on the basis of the measure of central tendency of the correction values in the recognition region A36. For example, a statistical value such as a mean, a median, and a mode of the correction values in the recognition region A36 can be used as the measure of central tendency.

As described above, according to the present embodiment, the reliability degree map generation unit 126 performs the processing of smoothing the exposure count of each pixel within the predetermined range centered on the pixel on the entire image region, and calculates the correction value of the reliability degree for each pixel in the entire image region. Then, since the score correction unit 127 corrects the reliability degree on the basis of the correction value, it is possible to calculate, with higher accuracy, the reliability degree reflecting the pixel exposure count.

As a result, even in a case where there is a difference in pixel exposure count, the value of the reliability degree after the correction can be uniformly processed, so that the recognition accuracy of the recognition processing can be further increased.

### FOURTH EMBODIMENT

An information processing system 1 according to a fourth embodiment is different from the information processing system 1 according to the first embodiment in that the correction value of the reliability degree can be calculated on the basis of pixel dynamic range. Hereinafter, differences from the information processing system 1 according to the first embodiment will be described.

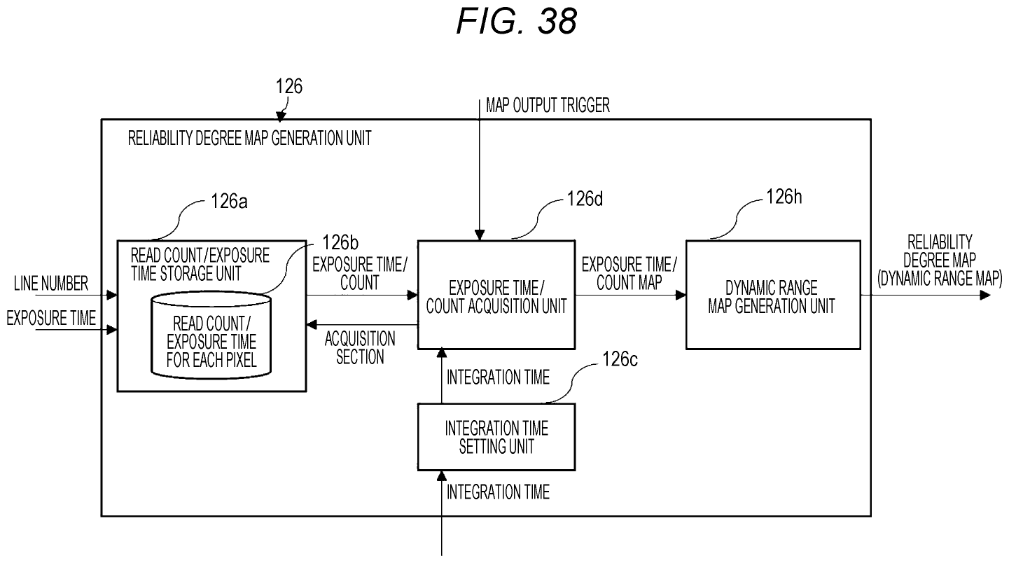

FIG. 38 is a block diagram of a reliability degree map generation unit 126 according to the fourth embodiment. As illustrated in FIG. 38, the reliability degree map generation unit 126 further includes a dynamic range map generation unit 126h.

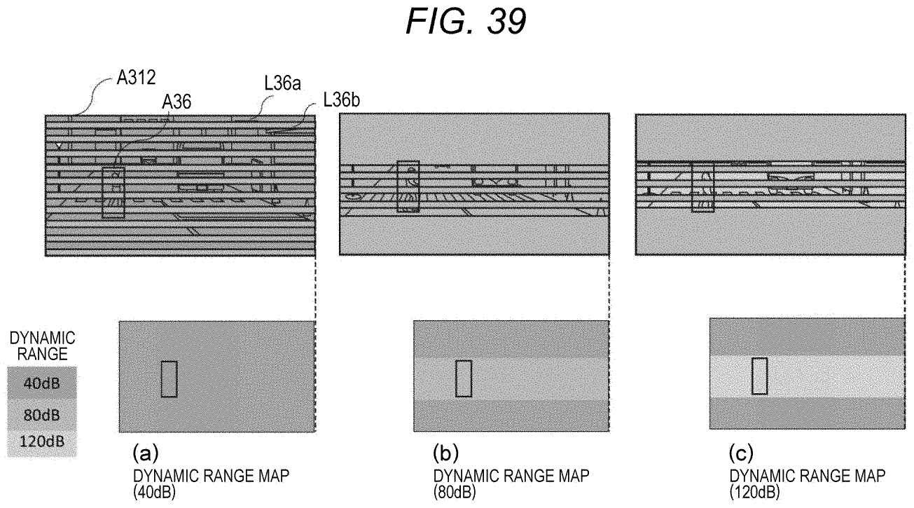

FIG. 39 is a diagram schematically illustrating a relation with a dynamic range of line data L36a. The upper diagram illustrates the line data L36a and an unread region L36b, and the lower diagram illustrates a reliability degree map. Here, it is a dynamic range map. (a) illustrates a case where the dynamic range of the line data L36a is 40 db, (b) illustrates a case where the dynamic range is 80 db, and (c) illustrates a case where the dynamic range is 120 db.

The dynamic range map generation unit 126h performs the processing of smoothing the dynamic ranges of the pixels within a predetermined range centered on the pixel on the entire image region, and calculates a correction value of the reliability degree for each pixel in the entire image region. For example, the smoothing operation processing is filtering processing for reducing high frequency components.

As illustrated in FIG. 39, in the present embodiment, for example, it is assumed that the predetermined range on which the smoothing operation processing is performed is a rectangular range of 5*5 pixels. With such processing, in FIG. 35(a), although there is a variation depending on the pixel position, the correction value of each pixel is approximately 20. On the other hand, in FIG. 35(b), the exposure count of the region where the line data L36a is read is 40, and in FIG. 35(c), the exposure count of the region where the line data L36a is read is 80. Furthermore, in a region where no data is read, the reading frequency is 0. Note that the dynamic range map generation unit 126h normalizes the correction values into a range of 0.0 to 1.0, for example.

The score correction unit 127 corrects the reliability degree corresponding to the recognition region A36 on the basis of the measure of central tendency of the correction values in the recognition region A36. For example, a statistical value such as a mean, a median, and a mode of the correction values in the recognition region A36 can be used as the measure of central tendency.

As described above, according to the present embodiment, the reliability degree map generation unit 126 performs the processing of smoothing the dynamic ranges of the pixels within the predetermined range centered on the pixel on the entire image region, and calculates the correction value of the reliability degree for each pixel in the entire image region. Then, since the score correction unit 127 corrects the reliability degree on the basis of the correction value, it is possible to calculate, with higher accuracy, the reliability degree reflecting the pixel dynamic range. As a result, even in a case where there is a difference in pixel dynamic range, the value of the reliability degree after the correction can be uniformly processed, so that the recognition accuracy of the recognition processing can be further increased.

### FIFTH EMBODIMENT

An information processing system 1 according to a fifth embodiment is different from the information processing system 1 according to the first embodiment in that the information processing system 1 according to the fifth embodiment includes a map combining unit that combines correction values of various reliability degrees. Hereinafter, differences from the information processing system 1 according to the first embodiment will be described.

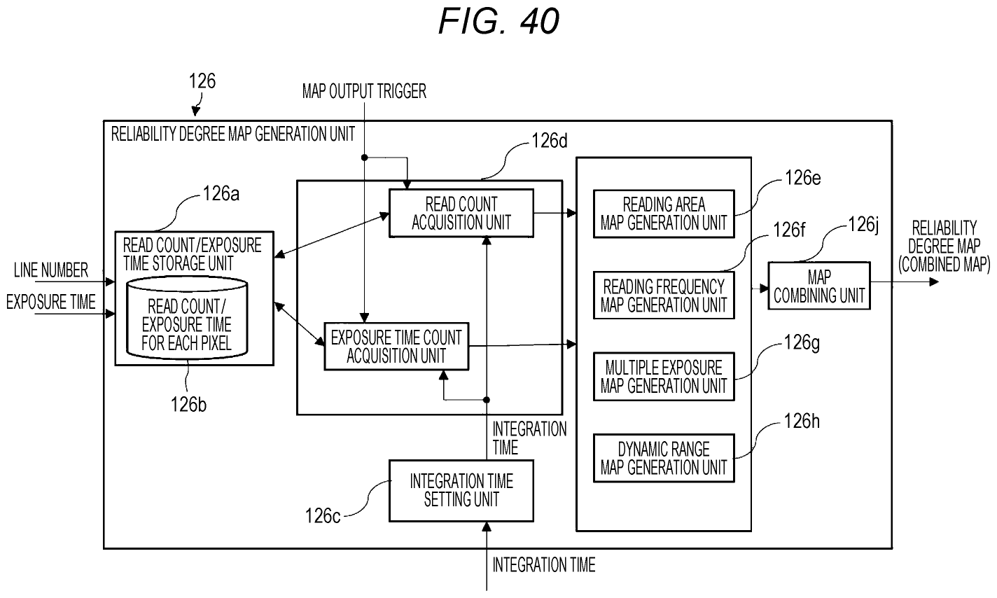

FIG. 40 is a block diagram of a reliability degree map generation unit 126 according to the fifth embodiment. As illustrated in FIG. 40, the reliability degree map generation unit 126 further includes a map combining unit 126j.

The map combining unit 126j can combine the output values of the reading area map generation unit 126e, the reading frequency map generation unit 126f, the multiple exposure map generation unit 126g, and the dynamic range map generation unit 126h.

The map combining unit 126j multiplies the correction value for each pixel to combine the correction values as represented by expression (1):

[Math. 1]

rel_map=rel_map1*rel_map2*rel_map3* . . . rel_mapn (1)

where, rel_map1 denotes the correction value of each pixel output by the reading area map generation unit 126e, rel_map2 denotes the correction value of each pixel output by the reading frequency map generation unit 126f, rel_map3 denotes the correction value of each pixel output by the multiple exposure map generation unit 126g, and rel_map4 denotes the correction value of each pixel output by the dynamic range map generation unit 126h. In a case of multiplication, if any one of the correction values is 0, a combined correction value rel_map becomes 0, so that it is possible to perform recognition processing shifted to a safer side.

The map combining unit 126j performed weighted-addition on the correction value of each pixel to combine the correction values as represented by expression (2):

[Math. 2]

rel_map=rel_map1*coef1+rel_map2*coef2+rel_map3*coef3+ . . . rel_mapn*coefn (2)

where, coef1, coef2, coef3, and coef4 each denote a weighting factor. In a case of weighted-addition of the correction value, it is possible to obtain the combined correction value rel_map according to the contribution of each correction value. Note that a correction value based on a value of a different sensor such as a depth sensor may be combined with the value of rel_map.

As described above, according to the present embodiment, the map combining unit 126j combines the output values of the reading area map generation unit 126e, the reading frequency map generation unit 126f, the multiple exposure map generation unit 126g, and the dynamic range map generation unit 126h. As a result, it is possible to generate the correction value in consideration of the value of each correction value, and the value of the reliability degree after the correction can be uniformly processed, so that the recognition accuracy of the recognition processing can be further increased.

### SIXTH EMBODIMENT

(6-1. Application example of technology of present disclosure)

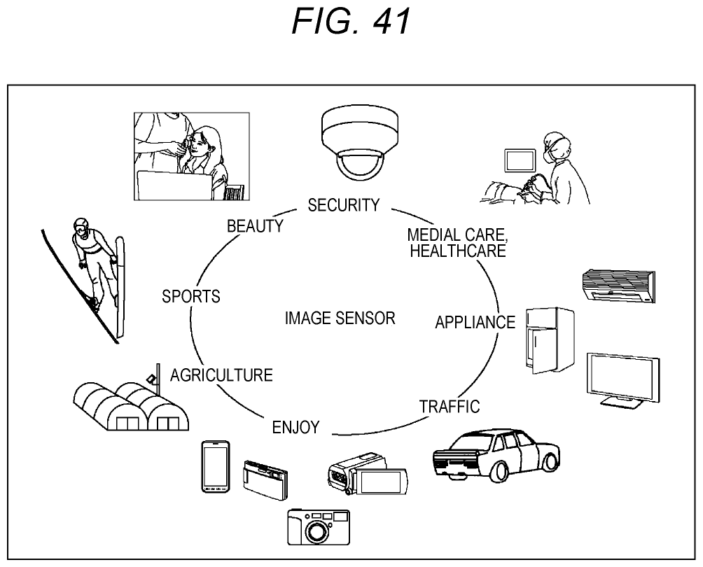

Next, as a sixth embodiment, an application example of the information processing device 2 according to the first to fifth embodiments of the present disclosure will be described. FIG. 41 is a diagram illustrating usage examples of the information processing device 2 according to the first to fifth embodiments. Note that, in the following, in a case where it is not particularly necessary to distinguish, the information processing device 2 will be described as a representative.

The information processing device 2 described above is applicable to, for example, various cases where light such as visible light, infrared light, ultraviolet light, or X-rays is sensed, and recognition processing is performed on the basis of the sensing result as follows.
A device that captures an image to be used for viewing, such as a digital camera and a portable device with a camera function.
A device used for traffic, such as an in-vehicle sensor that captures images of a front view, rear view, surrounding view, inside view, and the like of an automobile for safe driving such as automatic braking and recognition of a driver's condition, a monitoring camera that monitors a traveling vehicle or a road, and a distance measurement sensor that measures a distance between vehicles.
A device used for home electrical appliances such as a television, a refrigerator, and an air conditioner in order to capture an image of a gesture of a user to control an appliance in accordance with the gesture.
A device used for medical care or health care, such as an endoscope and a device that performs angiography by receiving infrared light.
A device used for security, such as a surveillance camera for crime prevention and a camera for personal authentication.
A device used for beauty care, such as a skin measuring instrument that captures an image of skin and a microscope that captures an image of a scalp.
A device used for sports, such as an action camera and a wearable camera used for sports and the like.
A device used for agriculture, such as a camera for monitoring a condition of a field or crops.

(6-2. Application Example to Moving Object)

The technology according to the present disclosure (present technology) is applicable to various products. For example, the technology according to the present disclosure may be implemented as a device installed on any type of moving object such as an automobile, an electric automobile, a hybrid electric automobile, a motorcycle, a bicycle, a personal transporter, a plane, a drone, a ship, and a robot.

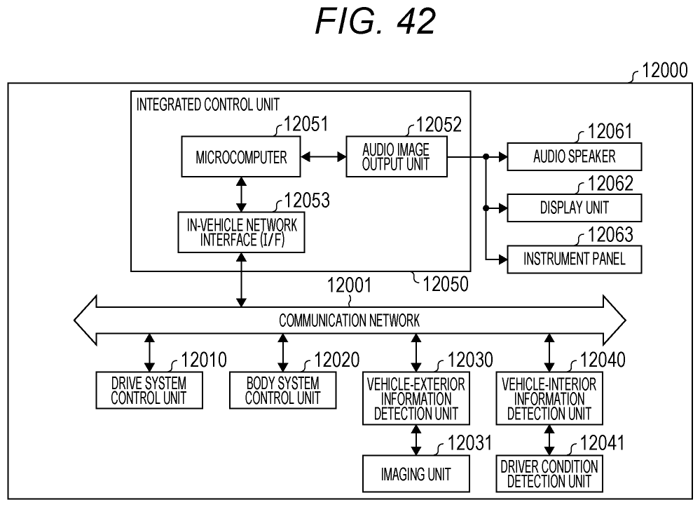

FIG. 42 is a block diagram illustrating a schematic configuration example of a vehicle control system that is an example of a moving object control system to which the technology according to the present disclosure is applicable.

The vehicle control system 12000 includes a plurality of electronic control units connected over a communication network 12001. In the example illustrated in FIG. 42, the vehicle control system 12000 includes a drive system control unit 12010, a body system control unit 12020, a vehicle-exterior information detection unit 12030, a vehicle-interior information detection unit 12040, and an integrated control unit 12050. Furthermore, as functional components of the integrated control unit 12050, a microcomputer 12051, an audio image output unit 12052, and an in-vehicle network interface (I/F) 12053 are illustrated.

The drive system control unit 12010 controls operation of devices related to a drive system of a vehicle in accordance with various programs. For example, the drive system control unit 12010 functions as a control device of a driving force generation device for generating a driving force of the vehicle such as an internal combustion engine or a driving motor, a driving force transmission mechanism for transmitting the driving force to wheels, a steering mechanism for adjusting a steering angle of the vehicle, a braking device for generating a braking force of the vehicle, and the like.

The body system control unit 12020 controls operation of various devices installed on the vehicle body in accordance with various programs. For example, the body system control unit 12020 functions as a control device of a keyless entry system, a smart key system, a power window device, or various lamps such as a headlamp, a tail lamp, a brake lamp, a turn signal, or a fog lamp. In this case, radio waves transmitted from a portable device that substitutes for a key or signals of various switches can be input to the body system control unit 12020. Upon receipt of such radio waves or signals, the body system control unit 12020 controls a door lock device, the power window device, the lamps, or the like of the vehicle.

The vehicle-exterior information detection unit 12030 detects information regarding the exterior of the vehicle on which the vehicle control system 12000 is installed. For example, an imaging unit 12031 is connected to the vehicle-exterior information detection unit 12030. The vehicle-exterior information detection unit 12030 causes the imaging unit 12031 to capture an image of an outside view seen from the vehicle, and receives the captured image data. The vehicle-exterior information detection unit 12030 may perform object detection processing of detecting an object such as a person, a vehicle, an obstacle, a sign, or a character on a road surface or distance detection processing of detecting a distance to such an object on the basis of the received image.

The imaging unit 12031 is an optical sensor that receives light and outputs an electric signal corresponding to the intensity of the received light. The imaging unit 12031 can output the electric signal as an image or can output the electric signal as distance information. Furthermore, the light received by the imaging unit 12031 may be visible light or invisible light such as infrared rays.

The vehicle-interior information detection unit 12040 detects vehicle-interior information. For example, a driver condition detection unit 12041 that detects a condition of a driver is connected to the vehicle-interior information detection unit 12040. The driver condition detection unit 12041 may include, for example, a camera that captures an image of the driver, and the vehicle-interior information detection unit 12040 may calculate a degree of fatigue or a degree of concentration of the driver or may determine whether or not the driver is dozing on the basis of the detection information input from the driver condition detection unit 12041.

The microcomputer 12051 may calculate a control target value of the driving force generation device, the steering mechanism, or the braking device on the basis of the information regarding the inside and outside of the vehicle acquired by the vehicle-exterior information detection unit 12030 or the vehicle-interior information detection unit 12040, and output a control command to the drive system control unit 12010. For example, the microcomputer 12051 can perform coordinated control for the purpose of implementing a function of an advanced driver assistance system (ADAS) including vehicle collision avoidance or impact mitigation, follow-up traveling based on an inter-vehicle distance, traveling with the vehicle speed maintained, vehicle collision warning, vehicle lane departure warning, or the like.

Furthermore, the microcomputer 12051 can perform coordinated control for the purpose of automated driving or the like in which the vehicle autonomously travels without depending on driver's operation by controlling the driving force generation device, the steering mechanism, the braking device, or the like on the basis of the information regarding surroundings of the vehicle acquired by the vehicle-exterior information detection unit 12030 or the vehicle-interior information detection unit 12040.

Furthermore, the microcomputer 12051 can output a control command to the body system control unit 12020 on the basis of the vehicle-exterior information acquired by the vehicle-exterior information detection unit 12030. For example, the microcomputer 12051 can perform coordinated control for the purpose of preventing glare, such as switching from a high beam to a low beam, by controlling the headlamp in accordance with the position of a preceding vehicle or an oncoming vehicle detected by the vehicle-exterior information detection unit 12030.

The audio image output unit 12052 transmits an output signal of at least one of a sound or an image to an output device capable of visually or audibly notifying the occupant of the vehicle or the outside of the vehicle of information. In the example illustrated in FIG. 36, an audio speaker 12061, a display unit 12062, and an instrument panel 12063 are illustrated as output devices. The display unit 12062 may include, for example, at least one of an on-board display or a head-up display.

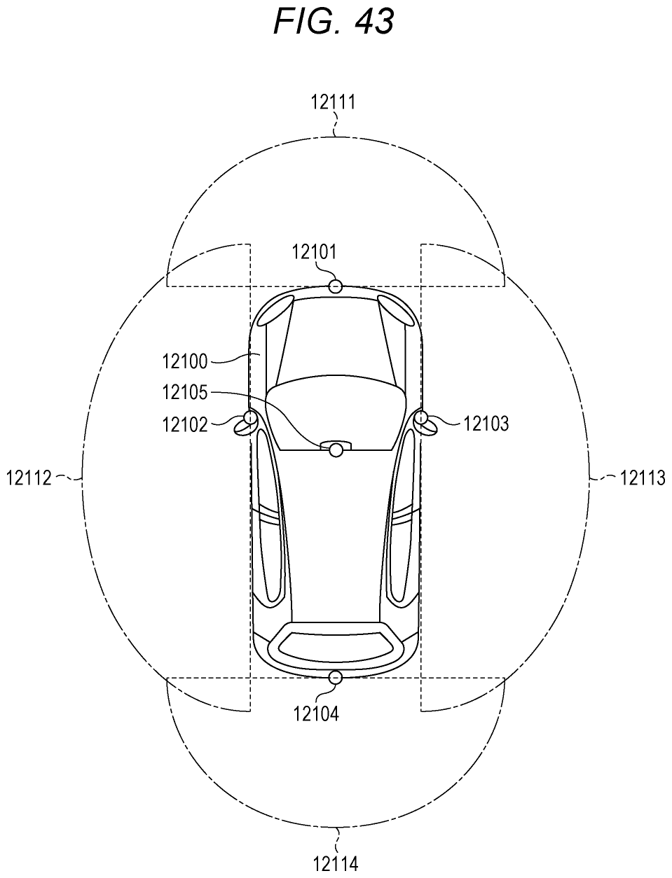

FIG. 43 is a diagram illustrating an example of an installation position of the imaging unit 12031.

In FIG. 43, a vehicle 12100 includes imaging units 12101, 12102, 12103, 12104, 12105 as the imaging unit 12031.

The imaging units 12101, 12102, 12103, 12104, 12105 are provided, for example, at least one of a front nose, a side mirror, a rear bumper, a back door, or an upper portion of a windshield in a vehicle interior of the vehicle 12100. The imaging unit 12101 provided at the front nose and the imaging unit 12105 provided at the upper portion of the windshield in the vehicle interior mainly capture an image of a front view seen from the vehicle 12100. The imaging units 12102, 12103 provided at the side mirrors mainly capture images of side views seen from the vehicle 12100. The imaging unit 12104 provided at the rear bumper or the back door mainly capture an image of a rear view seen from the vehicle 12100. The images of the front view acquired by the imaging units 12101, 12105 are mainly used for detecting a preceding vehicle, a pedestrian, an obstacle, a traffic light, a traffic sign, a lane, or the like.

Note that FIG. 43 illustrates an example of respective imaging ranges of the imaging units 12101 to 12104. An imaging range 12111 indicates an imaging range of the imaging unit 12101 provided at the front nose, imaging ranges 12112, 12113 indicate imaging ranges of the imaging units 12102, 12103 provided at the side mirrors, respectively, and an imaging range 12114 indicates an imaging range of the imaging unit 12104 provided at the rear bumper or the back door. For example, it is possible to obtain a bird's-eye view image of the vehicle 12100 by superimposing image data captured by the imaging units 12101 to 12104 on top of one another.

At least one of the imaging units 12101 to 12104 may have a function of acquiring distance information. For example, at least one of the imaging units 12101 to 12104 may be a stereo camera including a plurality of imaging elements, or may be an imaging element having pixels for phase difference detection.

For example, the microcomputer 12051 obtains a distance to a three-dimensional object in each of the imaging ranges 12111 to 12114 and a temporal change in the distance (speed relative to the vehicle 12100) on the basis of the distance information obtained from the imaging units 12101 to 12104, so as to extract, as a preceding vehicle, a three-dimensional object traveling at a predetermined speed (for example, 0 km/h or more) in substantially the same direction as the vehicle 12100, in particular, the closest three-dimensional object on a traveling path of the vehicle 12100. Furthermore, the microcomputer 12051 can set in advance an inter-vehicle distance that needs to be maintained relative to the preceding vehicle, and perform automated deceleration control (including follow-up stop control), automated acceleration control (including follow-up start control), or the like. As described above, it is possible to perform coordinated control for the purpose of, for example, automated driving in which a vehicle autonomously travels without depending on the operation of the driver.

For example, on the basis of the distance information obtained from the imaging units 12101 to 12104, the microcomputer 12051 can classify three-dimensional object data regarding three-dimensional objects into a two-wheeled vehicle, a standard-sized vehicle, a large-sized vehicle, a pedestrian, and other three-dimensional objects such as a utility pole and extract the three-dimensional object data for use in automated avoidance of obstacles. For example, the microcomputer 12051 identifies obstacles around the vehicle 12100 as an obstacle that can be visually recognized by the driver of the vehicle 12100 and an obstacle that is difficult to be visually recognized. Then, the microcomputer 12051 determines a collision risk indicating a risk of collision with each obstacle, and when the collision risk is greater than or equal to a set value and there is a possibility of collision, the microcomputer 12051 can give driver assistance for collision avoidance by issuing an alarm to the driver via the audio speaker 12061 or the display unit 12062 or performing forced deceleration or avoidance steering via the drive system control unit 12010.

At least one of the imaging units 12101 to 12104 may be an infrared camera that detects infrared rays. For example, the microcomputer 12051 can recognize a pedestrian by determining whether or not the pedestrian is present in the images captured by the imaging units 12101 to 12104. Such pedestrian recognition is performed by, for example, a procedure of extracting feature points in the images captured by the imaging units 12101 to 12104 as infrared cameras, and a procedure of performing pattern matching processing on a series of feature points indicating an outline of an object to determine whether or not the object is a pedestrian. When the microcomputer 12051 determines that a pedestrian is present in the images captured by the imaging units 12101 to 12104 and recognizes the pedestrian, the audio image output unit 12052 controls the display unit 12062 to display the images with a square contour line for emphasis on the recognized pedestrian superimposed on the images. Furthermore, the audio image output unit 12052 may control the display unit 12062 to display an icon or the like indicating a pedestrian at a desired position.

An example of the vehicle control system to which the technology according to the present disclosure is applicable has been described above. The technology according to the present disclosure is applicable to the imaging unit 12031 and the vehicle-exterior information detection unit 12030 among the above-described components. Specifically, for example, the sensor unit of the information processing device 1 is applied to the imaging unit 12031, and the recognition processing unit 12 is applied to the vehicle-exterior information detection unit 12030. The recognition result output from the recognition processing unit 12 is passed to the integrated control unit 12050 over the communication network 12001, for example.

As described above, applying the technology according to the present disclosure to the imaging unit 12031 and the vehicle-exterior information detection unit 12030 makes it possible to perform recognition of an object at a short distance and recognition of an object at a long distance and to perform recognition of objects at a short distance with high simultaneity, so that it is possible to give driver assistance in a more reliable manner.

Note that the effects described herein are merely examples and are not limited, and other effects may be provided.

Note that the present technology may have the following configurations.
(1)

An information processing device including:
a reading unit configured to set, as a read unit, a part of a pixel region in which a plurality of pixels is arranged in a two-dimensional array, and control reading of a pixel signal from a pixel included in the pixel region; and
a reliability degree calculation unit configured to calculate a reliability degree of a predetermined region in the pixel region on the basis of at least one of an area, a read count, a dynamic range, or exposure information of a region of a captured image, the region being set and read as the read unit.
(2)

In the information processing device according to (1),
the reliability degree calculation unit includes a reliability degree map generation unit configured to calculate a correction value of the reliability degree for each of the plurality of pixels on the basis of at least one of the area, the read count, the dynamic range, or the exposure information of the region of the captured image and generate a reliability degree map in which the correction values are arranged in a two-dimensional array.
(3)

In the information processing device according to (1) or (2),
the reliability degree calculation unit further includes a correction unit configured to correct the reliability degree on the basis of the correction value of the reliability degree.
(4)

In the information processing device according to (3),
the correction unit corrects the reliability degree in accordance with a measure of central tendency of the correction values based on the predetermined region.
(5)

In the information processing device according to (1),
the reading unit reads the pixels included in the pixel region as line image data.
(6)

In the information processing device according to (1),
the reading unit reads the pixels included in the pixel region as grid-like or checkered sampling image data.

(7)

The information processing device according to (1), further including
a recognition processing execution unit configured to recognize a target object in the predetermined region.

(8)

In the information processing device according to (4),
the correction unit calculates the measure of central tendency of the correction values on the basis of a receptive field in which a feature in the predetermined region is calculated.

(9)

In the information processing device according to (2),
the reliability degree map generation unit generates at least two types of reliability degree maps on the basis of each of at least two pieces of the information regarding an area, the information regarding a read count, the information regarding a dynamic range, or the information regarding exposure,
the information processing device further including a combining unit configured to combine the at least two types of reliability degree maps.
(10)

In the information processing device according to (1),
the predetermined region in the pixel region is a region based on at least one of a label or a category associated with each pixel by semantic segmentation.
(11)

An information processing system including:
a sensor unit having a plurality of pixels arranged in a two-dimensional array; and
a recognition processing unit, in which
the recognition processing unit includes:
a reading unit configured to set, as a reading pixel, a part of a pixel region of the sensor unit, and control reading of a pixel signal from a pixel included in the pixel region; and
a reliability degree calculation unit configured to calculate a reliability degree of a predetermined region in the pixel region on the basis of at least one of an area, a read count, a dynamic range, or exposure information of a region of a captured image, the region being set and read as the read unit.
(12)

An information processing method including:
setting, as a read unit, a part of a pixel region in which a plurality of pixels is arranged in a two-dimensional array, and controlling reading of a pixel signal from a pixel included in the pixel region; and
calculating a reliability degree of a predetermined region in the pixel region on the basis of at least one of an area, a read count, a dynamic range, or exposure information of a region of a captured image, the region being set and read as the read unit.
(13)

A program for causing a computer to execute as a recognition processing unit:
setting, as a read unit, a part of a pixel region in which a plurality of pixels is arranged in a two-dimensional array, and controlling reading of a pixel signal from a pixel included in the pixel region; and
calculating a reliability degree of a predetermined region in the pixel region on the basis of at least one of an area, a read count, a dynamic range, or exposure information of a region of a captured image, the region being set and read as the read unit.

### REFERENCE SIGNS LIST

1 Information processing system
2 Information processing device
10 Sensor unit
12 Recognition processing unit
110 Reading unit
124 Recognition processing execution unit
125 Reliability degree calculation unit
126 Reliability degree map generation unit
127 Score correction unit

1. An information processing device comprising:
a reading unit configured to set, as a read unit, a part of a pixel region in which a plurality of pixels is arranged in a two-dimensional array, and control reading of a pixel signal from a pixel included in the pixel region; and
a reliability degree calculation unit configured to calculate a reliability degree of a predetermined region in the pixel region on a basis of at least one of an area, a read count, a dynamic range, or exposure information of a region of a captured image, the region being set and read as the read unit.

2. The information processing device according to claim 1, wherein
the reliability degree calculation unit includes a reliability degree map generation unit configured to calculate a correction value of the reliability degree for each of the plurality of pixels on a basis of at least one of the area, the read count, the dynamic range, or the exposure information of the region of the captured image and generate a reliability degree map in which the correction values are arranged in a two-dimensional array.

3. The information processing device according to claim 1, wherein
the reliability degree calculation unit further includes a correction unit configured to correct the reliability degree on a basis of the correction value of the reliability degree.

4. The information processing device according to claim 3, wherein
the correction unit corrects the reliability degree in accordance with a measure of central tendency of the correction values based on the predetermined region.

5. The information processing device according to claim 1, wherein
the reading unit reads the pixels included in the pixel region as line image data.

6. The information processing device according to claim 1, wherein
the reading unit reads the pixels included in the pixel region as grid-like or checkered sampling image data.

7. The information processing device according to claim 1, further comprising
a recognition processing execution unit configured to recognize a target object in the predetermined region.

8. The information processing device according to claim 4, wherein
the correction unit calculates the measure of central tendency of the correction values on a basis of a receptive field in which a feature in the predetermined region is calculated.

9. The information processing device according to claim 2, wherein
the reliability degree map generation unit generates at least two types of reliability degree maps based on each of at least two pieces of the information regarding an area, the information regarding a read count, the information regarding a dynamic range, or the information regarding exposure,
the information processing device further comprising a combining unit configured to combine the at least two types of reliability degree maps.

10. The information processing device according to claim 1, wherein
the predetermined region in the pixel region is a region based on at least one of a label or a category associated with each pixel by semantic segmentation.

11. An information processing system comprising:
a sensor unit having a plurality of pixels arranged in a two-dimensional array; and
a recognition processing unit, wherein
the recognition processing unit includes:
a reading unit configured to set, as a read unit, a part of a pixel region of the sensor unit, and control reading of a pixel signal from a pixel included in the read unit; and
a reliability degree calculation unit configured to calculate a reliability degree of a predetermined region in the pixel region on a basis of at least one of an area, a read count, a dynamic range, or exposure information of a region of a captured image, the region being set and read as the read unit.

12. An information processing method comprising:
setting, as a read unit, a part of a pixel region in which a plurality of pixels is arranged in a two-dimensional array, and controlling reading of a pixel signal from a pixel included in the pixel region; and
calculating a reliability degree of a predetermined region in the pixel region on a basis of at least one of an area, a read count, a dynamic range, or exposure information of a region of a captured image, the region being set and read as the read unit.

13. A program for causing a computer to execute as a recognition processing unit:
setting, as a read unit, a part of a pixel region in which a plurality of pixels is arranged in a two-dimensional array, and controlling reading of a pixel signal from a pixel included in the pixel region; and
calculating a reliability degree of a predetermined region in the pixel region on a basis of at least one of an area, a read count, a dynamic range, or exposure information of a region of a captured image, the region being set and read as the read unit.
